(19) United States
(12) Patent Application Publication
(10) Pub. No.: US 2002/0062241 A1
(43) Pub. Date: May 23, 2002

(54) Apparatus and method for coding electronic direct marketing lists to common searchable format

(76) Inventors: Janet Rubio, Austin, TX (US); Jane Connelly, Austin, TX (US); Troy Anderson, Round Rock, TX (US)

Correspondence Address: WILSON SONSINI GOODRICH & ROSATI, 650 PAGE MILL ROAD, PALO ALTO, CA, 943041050

(21) Appl. No.: 09/794,668

(22) Filed: Feb. 27, 2001

Related U.S. Application Data
(60) Provisional application No. 60/219,726, filed on Jul. 19, 2000.
(60) Provisional application No. 60/227,555, filed on Aug. 23, 2000.

(51) Int. Cl. G06F 7/00; G06F 17/30; G06F 17/60

(52) U.S. Cl. 705/10; 705/7; 707/2; 707/3; 707/7

(57) ABSTRACT

An apparatus and method for processing direct marketing lists so that many different direct marketing lists may be aggregated into one system and searched uniformly begins by scanning the records incoming lists. The contents of the records of the incoming lists are compared to previously received records from other lists, whereby new records are assigned new universal identification codes (UICs) and records related to previously-received records are assigned common UICs. Also, the data field names/tags and data values, types, and formats of these fields may scanned and converted into uniform data dictionary (UDD) tables. The UDD tables allow lists with different names, types, values, etc., to be universally searched accurately and quickly with a standardized search engine and query syntax and format.

### RELATED APPLICATIONS

This application claims priority from co-pending U.S. provisional patent application Serial No. 60/219,726 (Attorney Reference No. 24431-701), filed on Jul. 19, 2000, entitled “Direct Marketing Information Processing System and Method Therefor”, naming Janet Rubio, Patrick Laughlin, and Wanda Holmes as inventors, and which is incorporated herein by reference in its entirety and for all purposes.

This application claims priority from co-pending U.S. provisional patent application Serial No. 60/227,555 (Attorney Reference No. 24431-702), filed on Aug. 23, 2000, entitled “Management System”, naming Wanda Holmes and Janet Rubio as inventors, and which is incorporated herein by reference in its entirety for all purposes.

### FIELD OF THE INVENTION

The present invention relates to an apparatus and method for electronically receiving, processing, and distributing computer data and more particularly to, converting data, data fields, and data records in many different direct marketing lists that are provided from different sources to a common searchable format via conversion tables.

### BACKGROUND OF THE INVENTION

In the direct marketing business, list owner entities either assemble customer/consumer lists during their normal course of business or eventually come to own customer lists over time. These customer lists generally contain an identification of the customers or consumers (e.g., their name, address, email, phone number, etc.) along with other information related to each customer set forth in the list. For example, a list owner such as Visa, Texaco, Sears, Dell, Wells Fargo and/or other entities may assemble over time a list of thousands to millions of customer records, along with the customer's contact information, and along with other valuable marketing information such as the ages, sex, hobbies, geographic location, recent purchases, income, and the like related to the specific customers. Each list is created by a different owner with different standards of data collection and recordation. For example, each list made by different owners may have different record IDs, different data field tags (e.g., some fields may be called children, other called dependents; some fields may be called hobbies others may be called activities; yet these fields generally contain the same useful information), and different data or data formats (e.g., age may be recorded in one list by birth date in MM/DD/YY format while another file may list age as decimal digit in years; e.g., 33 years old versus 07/15/67).

In order to profit from these lists and to generally improve worldwide marketing campaigns to consumers, the list owners will often seek to provide or rent their customer lists to third party end users in exchange for certain monetary fees or other consideration. The list owners generally use human agents called list managers and the list end users or buyers hire human agents called list brokers to enable the transfer of lists from one party to another. The parties generally are not concerned with the variation in data tags, fields, data, etc., since the process is fairly manual with significant human capitol involved in the analysis of the lists and their content. Generally, regardless of differences in the list, a list manager will come to understand their lists and their contents and know when a list is a good or poor fit with an end users target criterion.

However, this ad-hoc human-capitol-intensive system of providing lists between owners and end users is inflexible, inefficient, costly, and time consuming, whereby an improved system is desired for effectuating direct marketing list provision between list owners and list end users through brokers and managers. A more automated approach to processing, searching, and providing optimal direct marketing list information is hampered by the diverse data, data formats, data field tags, record IDs, and list identifiers used by the many different list owners.

In order to improve upon the ad-hoc and inefficient system for providing direct marketing lists described above, there is a need in this industry for an apparatus and method for converting lists with many different formats, data, tags, etc., to a common format that may be more universally processed with common methodologies and platforms.

### BRIEF DESCRITION OF THE DRAWINGS

FIG. 1 illustrates, in a block diagram, a computer system for receiving, storing, and distributing marketing lists between list owners and list end users.

FIG. 2 illustrates, in a flowchart, a method for receiving, processing, and posting marketing lists provided by a list owner for subsequent commercial access by end users using the system illustrated in FIG. 1.

FIG. 3 illustrates, in a flowchart, a method whereby an end user accesses, processes, and orders archived marketing lists using the system illustrated in FIG. 1.

FIG. 4 illustrates, in a flowchart, a method whereby an end user may on-line solicit and accept third party direct marketing bids where the third parties desires to commercially exploit the target marketing list created via the method of FIG. 3 to the benefit of the end user.

FIG. 5 illustrates, in a flowchart, a method whereby an end user may input his current marketing lists (i.e., house files) into the system of FIG. 1 and use massive amounts of stored customer information to update his current customer records for a fee.

FIG. 6 illustrates, in a flowchart, an end-to-end direct marketing method for updating and using customer lists in a marketing campaign using the on-line system and methods set forth in previous figures.

FIG. 7 illustrates, in a block diagram, a plurality of direct marketing lists or customer lists that are input into the system of FIG. 1.

FIG. 8 illustrates, in a block diagram, a universal identification code (UIC) table or data structure that may be formed so that related customer records across many different lists in the list database may be quickly associated with one another when processing or searching lists.

FIG. 9 illustrates, in block diagrams, the progression of updates in a UIC table as new list information comes into the system and as existing information in the system changes over time.

FIG. 10 illustrates, in a flowchart, a method for performing uniform data dictionary (UDD) processing on one or more direct marketing lists to allow the lists to be processed, accessed, and searches using a common interface and query language/construct.

FIG. 11 illustrates, in a block diagram form, age data field portions of three different lists to show why data across different lists needs UDD processing in order to create standardization and uniformity.

FIG. 12 illustrates, in a block diagram, the data structure of a UDD construct that may be used to map many different lists with different data field names/tag, data formats, data structures, data types, and the like whereby common searching may be performed.

FIG. 13 illustrates, in a block diagram, a UDD table that resulted for three simple direct marketing lists.

### DETAILED DESCRIPTION

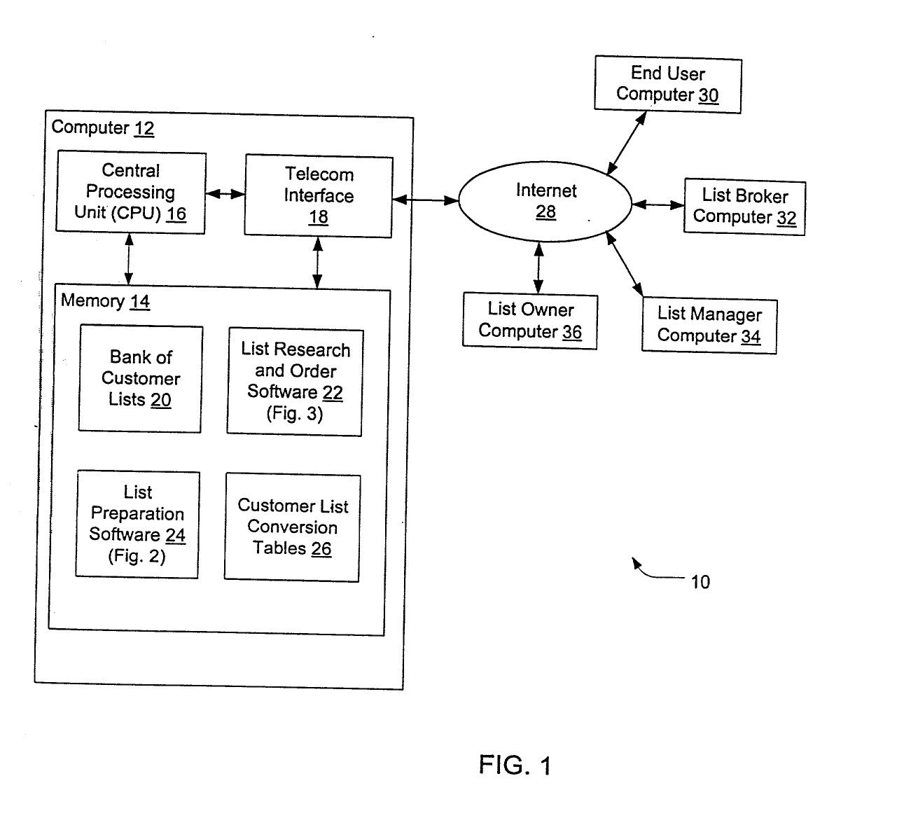

Generally, FIGS. 1-13 herein teach an improved apparatus and method for providing direct marketing lists or marketing lists between list owners and list end users. Unlike the human intensive prior art process discussed above, a list owner in the system taught herein will post lists within the on-line system by providing the list to a central processing computer. The central processing computer will pre-process the marketing list to remove all redundant and/or bad records and/or entries in the list(s) and present the lists for collective searching by many end users and list brokers. In addition, upon provision of a list into the system, the records within the list and each data field entry in each record are mapped to a universal identification code (UIC) and a uniform data dictionary (UDD) system. The UIC process is implemented so that the same record or same customer found in one or more different lists is identified within the system by a single common identifier. Having identified all records that are indicative of a certain person will simplify subsequent computer processing and allow an end user to implement more features. In addition, the UIC scheme may be used to identify people in the same household, people working for the same company, people in a same geographic area, or any other commonality that would be useful to have readily at hand when searching direct marketing lists.

The UDD is a table conversion construct that is created and used to map specific data fields and data formats within a record of a direct marketing list to a common set of fields and formats. This allows many lists with related, but potentially different, fields and formats to be converted to a common standard and searched within that common standard by a common end user input query. Statistical and other searchable data (e.g., counts of records with common characteristics) is also much easier to generate across many segmented and different lists through use of this common UDD conversion interface.

Once the lists are fully preprocessed and approved by the list owner or his agent, the lists are stored and posted for active searching and ordering by end users. An end user can log into the system and interactively and iteratively search and process any subset of thousands of user lists using the UIC and UDD information, in a short time, based upon one or more of many different criterion. The end user may quickly arrive at a de-duplicated list of prospective customers that optimally meets the end user's target marketing requirements. The end user will know an exact cost (or at least a very accurate estimate of the cost) for use of those contacts derived from the list and the end user will be provided with the number of useable names/records being purchased before the order is even placed.

Unlike the prior art processes, the process and system discussed herein in FIGS. 1-13 have one or more of the following advantages. First, instead of taking weeks from target identification to engaging in commercial customer contact, the process from target definition to customer contact will usually take less than a week using the apparatus and process discussed herein. Time to market is usually improved, customer information is less likely to get stale before use, and overall costs can be reduced. Since the on-line list broker service discussed herein can be performed entirely on-line by many brokers, owners, managers, and users in concert, this system achieves economies of scale, which are beneficial to all parties. In addition, since a large percentage of available lists can be scrutinized in parallel using similar search criterion, it is likely that a more optimal and rewarding target list data will result in the end. Unlike the prior art system, the end user knows the exact number of useful customers in the final target marketing list, the exact cost for such a list, and more detailed up front statistical information about the final list(s) before ordering the lists or waiting on timely and costly subsequent processing of their list order. On-line provision of lists allows for more effective tracking of metrics, including metrics that were never before feasible to industry brokers, managers, end users, and owners. Generally, the solution taught herein is one or more of more cost effective, faster, more predictable, more adaptable, and more user friendly than prior art list brokerage techniques. Also, the UIC and UDD constructs allow many different lists from different sources to be searched on a common and integrated platform that is easy to learn and repeatedly use.

FIGS. 1-6 will illustrate in greater detail the apparatus and method that is used to provide direct marketing lists between end users and list owners over electronic communication medium. FIGS. 1-6 are discussed in order to disclose an exemplary environment in which UIC and UDD constructs and methodologies may be used. After this environment is reviewed in FIGS. 1-6, FIGS. 7-13 will illustrated in more detail the UIC and UDD methodologies and how such methodologies and constructs may be used within computers and business methods, such as the direct marketing processes and systems of FIGS. 1-6.

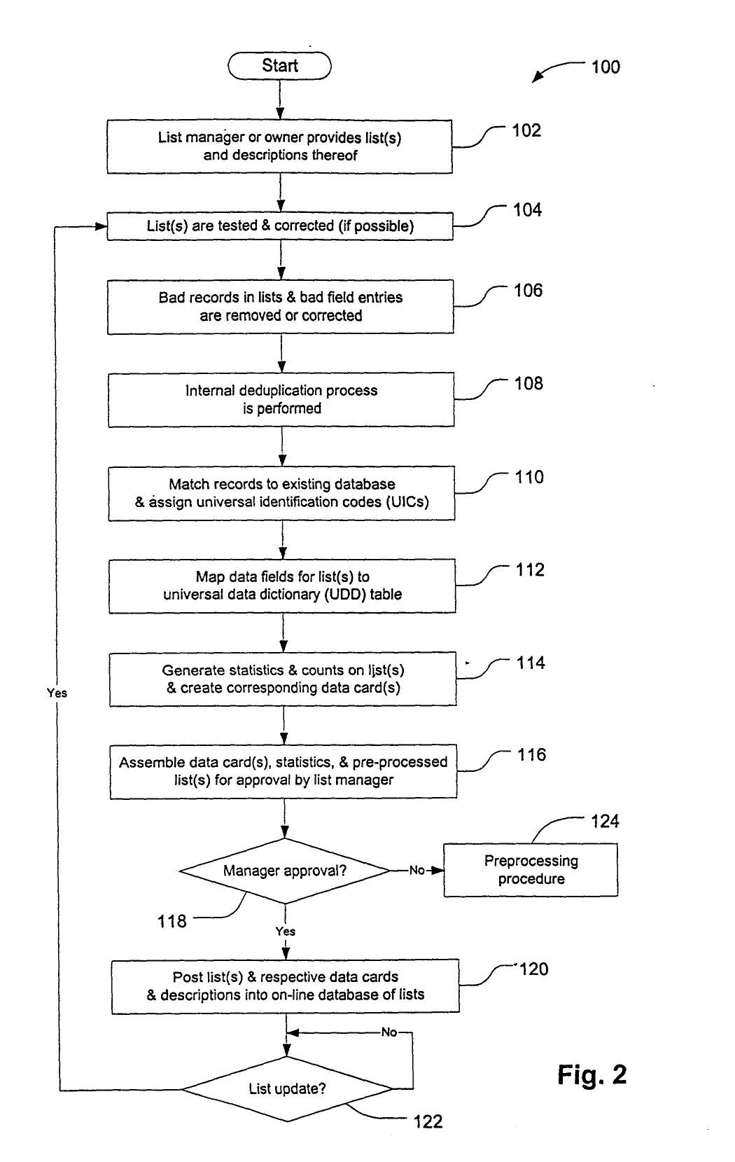

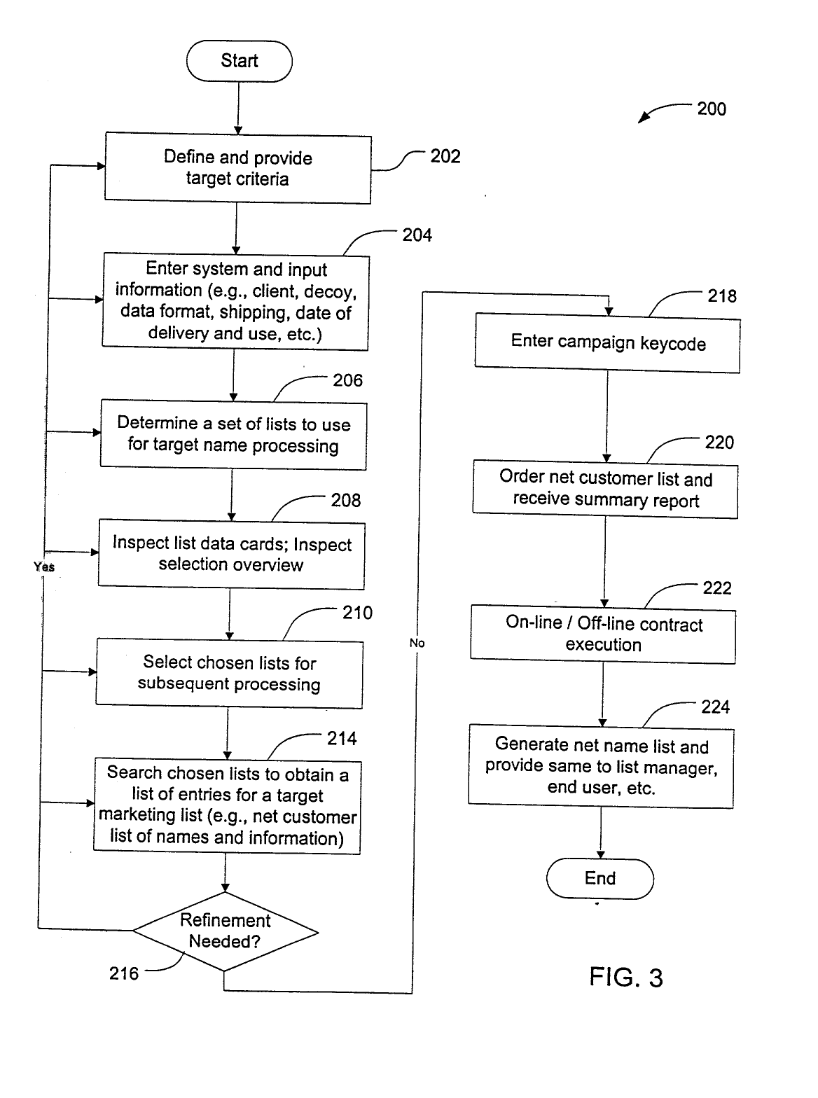

FIG. 1 illustrates a computer system 10 that is used to implement the direct marketing list collection, processing, and distribution operations set forth in FIGS. 2 and 3. System 10 is typically any general purpose or special purpose computer or microprocessor 12. In those cases, computer 12 may be a personal computer (PC), a network computer, a main frame, a supercomputer, a workstation, a collection or network of two or more computers, or any other data processing apparatus which can be used to store, process, and transmit digital or electronic information. The computer 12 generally contains three primary components referred to in FIG. 1 as a central processing unit (CPU) 16, a telecom interface or modem 18, and a memory system 14. Generally, the CPU 16 is one or more software execution devices such as a microprocessor, a microcontroller, a digital signal processor (DSP), or a combination of two or more of these execution units. The CPU 16 is connected to a memory system 14 through one or more conductive interface buses. The memory 14 consists of one or more devices that are used to store digital information. The memory 14 may contain one or more of static random accessory memory (SRAM), dynamic random access memory (DRAM), non-volatile memory, hard drives, tape back-up, compact disc, DVD, or other forms of computer storage medium. The CPU 16 and memory 14 interface to a telecom interface circuit 18 within the computer 12 through other conductive interconnects.

The telecom interface 18 is any circuit, modem, interface, or system that allows the computer 12 to electronically communicate with other computers over the internet 28 or local area networks (LANs), wide-area networks (WANs), optical fiber, twisted pair, Ethernet, FDDI, or other data communication systems. In different embodiments, the telecom interface 18 may enable asynchronous transfer mode (ATM) transmission, TCP/IP transmission, asymmetrical digital subscriber line (ADSL) transmission, ISDN transmission, analog modem transmission such as V.90 or K56Flex, cable modem transmission, optical carrier transmission such as OC-192 or OC-48, combinations thereof, and/or like transmissions.

The memory 14 of computer 12 contains data, data structures, and software that enables the central processing unit 16 to perform all computational functions necessary to receive, process, and deliver direct marketing lists or marketing lists via end users and list owners. By way of example using FIG. 1, a list owner may provide one or more marketing lists from their computer 36 to their list manager's computer 34. The list manager may then provide the one or more of the marketing lists from the computer 34 to the computer 12 via the Internet 28 or another wireless or wireline communication medium (or by computer readable medium such as magnetic disk or tape if such medium is preferred). In an alternative embodiment, the list owner may provide lists directly from the computer 36 into the computer 12 without using the list manager where the list manager may be optionally notified of the provision of such a list by one of either the computer 12 or the computer 36. In any event, the system 10 of FIG. 1 is used to provide one or more marketing lists from an external source to the computer 12 where in the computer 12 receives such information, processes it, and stores it within the bank of marketing lists or customer lists 20 illustrated in FIG. 1.

Note that the system used herein may be a distributed computing system wherein customer or marketing list data and records, and maybe even software that processes such information, is spread across a network of many computers. In one form, this distributed computing system would allow list owners to retain possession and control of their original lists and monitor access thereto while still obtaining most, if not all, of the benefit set forth herein. Nonetheless, the specific processing of the incoming lists is accomplished through use of some collection of software 24 and the specific operation of this software 24 is discussed in some detail in FIG. 2.

Once the software 24 has been used by computer 12 in order to create the bank of marketing lists 20 over time, the list broker software 22 is used to provide marketing lists from the list data bank 20 out across the Internet 28 to end users and/or list brokers. An end user, via a computer 30, and/or a list broker, via a computer 32, may transmit customer queries and perform list searches through the Internet 28 and the interface 18 on lists stored within or coupled to the computer 12. Using the list broker software 22, the computer 12 processes the query to select certain lists and records within those lists from the bank 20. The queries, processing, and searches may be iteratively changed and optimized as the user sees fit. In fact, various data provided by the software 22 with respect to the lists and data encountered by the end user may result in the end user or his list broker substantially modifying and changing the search target and criterion over time. The software 22 will eventually allow the end user or list broker to perform one of several final processing operations on the list data and will enable the end user or list broker to receive delivery of a selected set of customer data from the computer 12 that fits their queries and/or searches. Upon receipt of the selected customer data, the end user and/or the list broker may immediately use the list in commerce in order to make offers to existing customers and/or contact perspective customers to offer services, goods, or other commercial benefits to consumers via usage of the customer data.

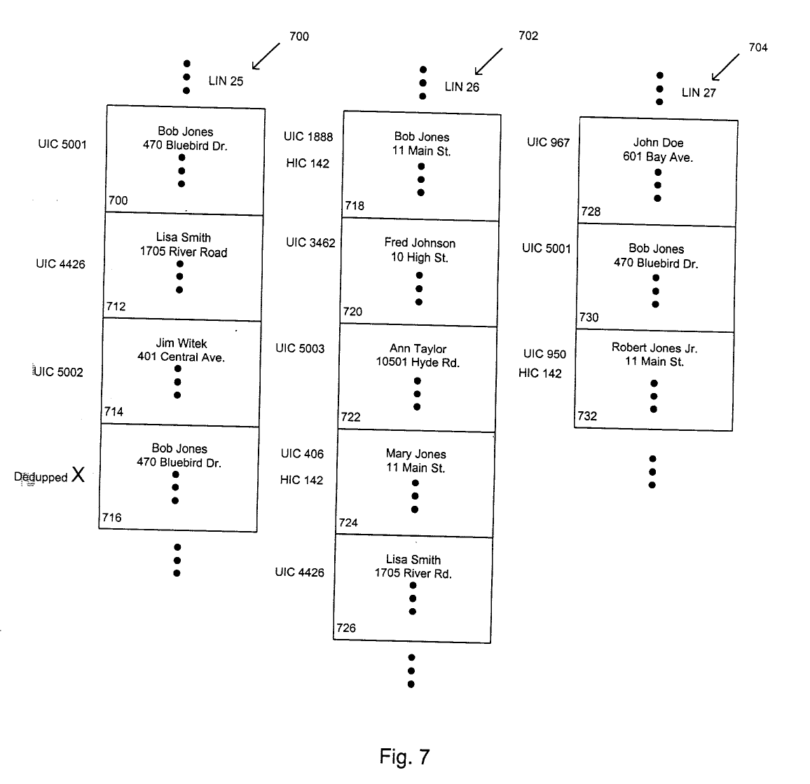

It is important to note that in one embodiment the lists set forth in data bank 20 are kept as near to their original condition as possible. In this embodiment, each list is kept in a file or structure that is separate or easily segmented from or identified among all other lists (i.e., the lists are not torn apart and aggregated into a master list). Changes to the lists, such as addition of common data fields, data format changes, additional tagged information, translations, and other modification to a list are done by preserving the original list as much as possible and making such changes via implementation of conversion tables set forth in memory area 26 of FIG. 1 (see FIGS. 7-13).

The process performed by the system of FIG. 1 may be better understood with reference to FIGS. 2 and 3. FIG. 2 illustrates a process 100 which may be used by a list manager, a list owner, and/or their agents to provide one or more direct marketing lists or marketing lists to the computer 12 of FIG. 1 for pre-processing and eventual end user rental. In a first step 102, the list manager and/or list owners provides one or more marketing lists to the computer 12. In a first embodiment, these lists may be provided in an electronic manner from the computers 34 and/or 36 through the Internet 28 or a like wireless or wireline communication network coupled to the computer 12. In other embodiments, the lists may be copied from the list owners computer or the computer operated by the list owners agent onto computer readable medium and transmitted by mail carrier or other physical carrier to the location of the computer 12 or a computer networked to computer 12. Such computer readable medium may include one or more of: magnetic tape, magnetic disc, compact disc, or like transportable computer readable medium. In another embodiment, paper data may be provided from a list owner or list manager to the entity controlling the computer 12. In this embodied, the entity controlling the computer 12 may scan or optical character recognize (OCR) as input the incoming paper data and prepare it for processing and presentation in electronic form within the computer 12.

In addition to the provision of the actual lists, the list manager and/or owner will also provide (or create in conjunction with the entity controlling the computer 12 upon or around delivery of the lists) one or more descriptions of the lists provided by the list manager or owner. These descriptions will be stored with the list within computer 12 and used by end users in order to enable efficient searches of lists in order to obtain target customers that fit specific marketing needs. Some descriptions may be brief and bulleted lists of characteristics of the data list, fields or records in a data base, or a full text description of the contents of the list or certain characteristics of the list. For example, a description may provide text or data fields which indicate to the computer or end user the number of users within the list, specific characteristics of the people in the list such as income, employer, purchasing habits, hobbies, individual's business title, various business markets, computing system types employed, consultants used, revenue, profit margins, number of employees, etc., and may include other information related to the list.

After performance of the step 102 in FIG. 2, the entity that is controlling the computer 12 will transform incoming information to an electronic form that is compatible with the other direct marketing data information stored in the computer 12 via a step 104. In addition to performing this transformation, which may include de-encryption, de-compression, translation from one data base format to another, or other computer processing, the step 104 will be used to computer test the incoming lists to ensure that the lists are provided on functional computer readable medium. If the lists cannot be properly accessed and read by the computer 12, an error message will be sent or recorded by the computer 12 so that the appropriate list owner and/or list manager may correct the problem with a subsequent re-transmission of the functioning list to replace the nonfunctioning list within computer 12. In addition, in step 106, the computer 12 will generally scan through every record of each list received in order to determine if any one particular record within a list is non-functioning or if one or more records contains data that is corrupted, incomplete, or detectably inaccurate. The record-by-record search is useful in some cases since while some marketing lists may be generally readable and functional as a whole, a few records, a few entries, or some data fields within one or more records of a list may contain bugs, incorrect data, or have like defects which may be immediately corrected or at least detected in step 106. In other cases, a record may be accessed only to determine that the address does not exist or that certain information in the database is otherwise undesirable to an end user (i.e., the age of the customer is too young, requires parental consent in some cases, and would create Internet legal issues and liability if used over the Internet). In some cases, correction of these issues may be done by flagging that particular record for the end user so that the end user is properly notified of special conditions or circumstances associated with that record. If such errors are critical and cannot be corrected or worked-around in step 106, an error message is either transmitted or recorded by the computer 12 to provide notice to the list owner or list manager of the presence of the error.

After steps 104 and 106 have been performed, one or more customer or marketing lists have been received and configured for subsequent computer processing within the computer 12. The computer 12 will then use step 108 executed from software 24 in FIG. 1 to scan and identify each record within each marketing list. Within a single marketing list, it is not uncommon to find two or more records that are associated with the same target customer (e.g., two records to the same Sally Anderson in the list). In these cases where duplicates exist, the subsequent purchase of duplicate entries within a list would not be incrementally beneficial to an end user and such redundant records within a marketing list are de-duplicated or purged from the list per step 108.

Within the bank of marketing lists 20, several hundred to several thousand different marketing lists may be present at any one given point in time. Some of these lists may contain tens of thousands of customers or records while other lists may contain hundreds of millions of customers or data records. In order to allow efficient search querying of these multiple lists by an end user, every record upon input into the computer 12 is scanned via a step 110. All records that identify the same customer or are associated with the same customer in all lists within the bank 20 are assigned a universal identification code (UIC). In other words, if the bank of marketing lists 20 contains 100 lists and the same customer or entity appears in four of the 100 lists, then those four records which indicate the same customer will be marked in a table and/or on the record with a universal identification code so that the system can easily determine the presence and location of the same customer in the four different lists. The tables that can be used to identify multiple customer entries across multiple lists and to uniquely identify specific customers for tracking and search purposes may be stored as part of the marketing list conversion tables 26 illustrated in FIG. 1. The UIC may be better understood with reference to the discussion of FIGS. 7-9 herein.

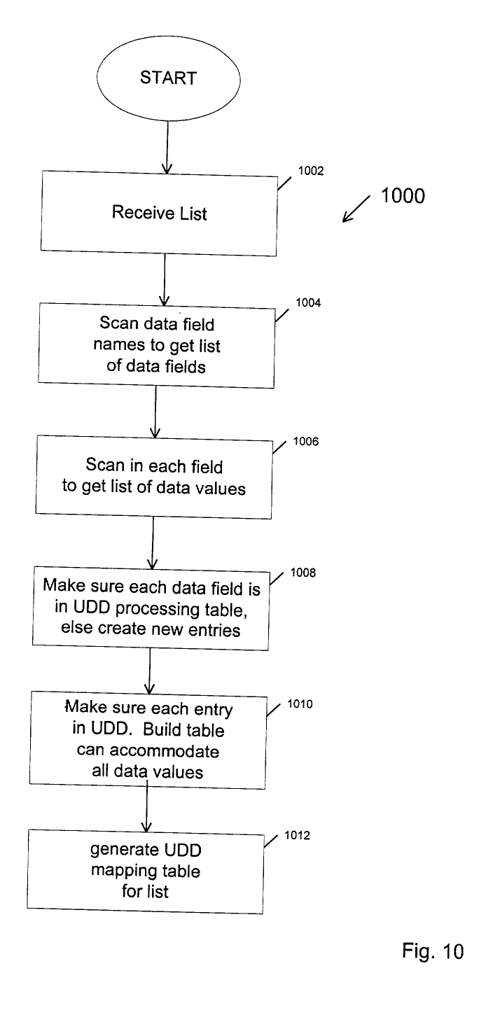

After step 110 is performed in FIG. 2, a step 112 is performed. In step 112, the software 24 of FIG. 1 will map specific data fields within each record of each marketing lists to a uniform data dictionary (UDD) convention. For example, a first list that is received by the computer 12 may contain a name field that is indexed as “Name” and an age field that is indexed as “Age”. Another list that is received by the computer 12 may contain a name field that is indexed as “Identity” and an age field that is identified as “Birth Date”. In order for these two different lists to be data field searched in a common and compatible manner, one or both of the lists data field tags must be mapped along with the data fields for the other lists to a common set of data field tags or identifiers. In addition, the specific data contained within a specific field may be in a varying format. For example, where an age field may contain the numerical value 33, a birth date field may contain the date Jul. 15, 1967. These two fields may generally indicate the same useful information for an end user but in order to enable effective searching of both of these lists in an easy and non-discriminatory manner, not only must a renaming of the data field occur to a common tag (e.g., age) but a reformatting and reprocessing of the content of the data field must also be performed by the computer 12. In this example, the data Jul. 15, 1967 must be converted to age 33. Note that the original data is not destroyed or changed. The original data remains with the list in data portion 20 of FIG. 1 while tables are used to map field names and field formats to interoperable data via the tables 26. Therefore, step 112 of FIG. 1 is used to convert data fields, the type of data stored in fields, and other data information within records of each list to a common format, which may be universally searched by a specific end user in an effective and efficient manner. Specifics of the UDD may be better understood with reference to the discussion of FIGS. 10-13 herein.

After performance of step 112, step 114 is used to generate statistics and/or count information on the list just received by the computer 12. In order to enable accurate, quick, universal, and cost effective search query of multiple lists, it would be useful for an end user to have searchable access to a statistical summary or set of counts associated directly with each lists within the bank of lists 20. For example, an end user may desire to know that a specific list contains predominately men and few women, whereas another lists contains customers largely located in zip codes within the southwestern United States, and whereas another list contains people who spend large amounts of money around Christmas time every year. The database may store counts where a list that contains 1000 records may contain some of the following counts:

| | |
|---|---|
| Total records: | 1000 |
| Male: | 555 |
| Female: | 445 |
| Below 20 years old: | 102 |
| Between 20 and 40 years old: | 677 |
| Older than 40 years old: | 221 |

Therefore, step 114 would process a single list and break out statistics for the list showing general demographics whereby end users can search these demographic or data card fields quickly and efficiently to find and then focus on only those few lists which have demographics that may be most desirable for reaching their marketing targets. Certain statistics and record counts based upon certain criterion will be assembled into a data card and stored along with the lists and the description provided in step 102 within the bank of marketing list 20 in FIG. 1.

In step 116, the data card derived in step 114, the statistics derived in step 114, and the pre-processed lists derived through steps 104-114 is assembled and provided either electronically or by carrier mail to the list manager or end user for final approval. Electronic provision may be either wireless or wireline. Steps 116 provides the list manager or owner with an opportunity to review such information and work with the entity controlling computer 12 to correct any information before presenting the list for general usage by worldwide end users. Therefore, in a step 118, if manager approval is not obtained, a re-processing or re-working procedure 124 is initiated with the list manager or list owner in an attempt to arrive at a workable compromise for that particular list. If no compromise is possible, the list may be discarded from the system and not used with any end user for commercial activity. If in step 118 manager or list owner approval is obtained either electronically or by mail, then step 120 is performed.

In step 120, the data card, descriptions, and processed lists that were approved by the manager or owner are posted from the bank of marketing list 20 for inspection, processing, ordering, and use by end users and/or list brokers. The specific process by which an end user or list broker or another agent of the end user or broker accesses, searches, orders, and/or commercializes such lists is set forth in greater detail with respect to FIG. 3 herein.

Since the data within the marketing lists stored within computer 12 is likely to change over time (e.g., name changes, new buying habits, address changes, etc.), occasional updates for specific lists or for specifics records within a specific list is occasionally and/or periodically received from a list owner or list manager. Provision of this upgrade may be in any format. An update may be in an entirely new list or may simply be a shorter list of records to be added, deleted, and/or modified within an existing list. With this list update information, a step 122 will be used to re-run one or more of the steps 104-120 in order to incorporate the new and/or improved customer information into the existing list for immediate beneficial use by end users or list brokers. Generally, the list's data card and/or description will contain date information describing how new or how old the information within the marketing list is at any given time.

Once lists are provided into the system via the process of FIG. 2, the process of FIG. 3 is used to extract information out from the system. FIG. 3 specifically illustrates a method 200 for providing an end user or list broker with access to the bank of marketing lists 20, allowing them to interactively and proactively search the lists 20, and allowing end users to order and receive target marketing list data for use in direct marketing commercial activity. Specifically, method 200 begins by performing step 202. In step 202 an end user or list broker generates target criterion which they will use to determine an appropriate target marketing list for use in commerce. As an example, an end user or list broker may create or be instructed to search for target customers that are male, under the age of 40, interested in football, and have salaries greater than $40,000 a year. Once the target criterion is known, the target criterion can be assembled onto paper or in electronic form for provision to the entity controlling computer 12. While most end users and/or list brokers will electronically interface with computer 12 in order to perform searches, certain end users or list brokers may contact the entity controlling computer 12 and provide via telephone, written instructions, facsimile, or like non-electronic media, the search criterion whereby an entity controlling computer 12 may perform such searches on behalf of and as a contractor for a certain list broker or end user.

If the end user or broker is using the on-line interfaces, the end user or list broker will enter the computer system 12 and input certain information. As an example, in step 204, the end user or list broker will enter a client identification tag, decoy information (i.e., information that is to be added to the final marketing list data to allow the end user to track customer contact), the desired data format required for the target marketing list (e.g., RTF, ASCII text, SQL, compression, encryption, etc.), shipping information (e.g., address, payment terms, etc.), delivery date requirements and limitations, a description of the intended use of the target marketing list (e.g., telemarketing, mass mailing, targeting web ads, etc.), and any other information which may be used to inform the computer 12 or list owners and list managers of important information related to the processing and/or use of one or more marketing lists or portions thereof.

In step 206, the user may scan one or more of the marketing lists resident within database 20 of FIG. 1 in a list-by-list fashion. When reviewing lists, the end user may specify that they want to view the data card or statistical information generated in step 114 of FIG. 2, description information generated in step 102 of FIG. 2, specific exemplary records stored within a list, or other information associated with any lists within the data base 20. In another embodiment, a subset of specific lists, which may be used for subsequent customer searches, may be identified through an electronic list search query. The list search query may be a Boolean search which looks for certain lists with certain characteristics (e.g., find lists with average age<40 and {interest=“football” or hobby=“sports”} and salary>=40,000). In another form, the search for specific lists may be conducted in a free language or free text searching format. In this case, the end user or broker will simply type “please find all lists that contain primarily males with an interest in sports, especially football, and that have an annual income of greater than $40,000 per year”. Once this free text query is entered, an intelligent agent will process the text to create a search that is highly likely to find a subset of lists of interest to the end user or broker. In another example, an end user may ask to assemble a group of all lists provided by a particular list owner or list source. In yet another example, a list owner may use an input query to select for subsequent processing all lists submitted to computer 12 after a certain target date. In summary, step 206 identifies a subset of the lists 20 within computer 12 for subsequent processing by the end user or broker so that all the millions of records in the database need not be searched exhaustively to find the few records that are of interest to the end user.

After certain lists are selected in step 206, a step 208 is performed. In step 208, the selected lists are presented to the end user or list broker along with accompanying information associated with the list (e.g., data card information or a summary report) to allow the list broker or end user to verify that the lists selected by their search in step 206 satisfactorily serve their particular target marketing goals. If these lists do not appear to suit the end user or broker's needs, then the end user may elect at this time to repeat one or more of steps 204-206 to obtain a different set of lists for subsequent processing that may better suit their needs. If the list(s) appear to be acceptable to the end user or list broker, the lists are then accepted in step 210 for further list/record processing.

In steps 206-210, specific lists were selected from database 20 of FIG. 1 for subsequent processing. Once these subsets of lists have been obtained, the step 214 of FIG. 3 is used to search these selected lists for specific records which may be of use to the end user or list broker and in accordance with the target criterion set forth in step 202. In step 214, the user may enter search criterion based on specific attributes, Boolean operations, data base key words, or any other targeted information including calling up archived or historical previous search records and processes that the end user has previously used within computer 12. Once a target record search query is developed in step 214 in either a complicated or simple manner, the search criterion is applied against the lists selected in steps 206-210. Given the application of universal identification codes (UIC) and uniform data dictionary (UDD) information in steps 110-112 in FIG. 2, subsequent identification of specific records within the selected lists that meet target criterion can be efficiently and effectively obtained and assembled. Upon searching of individual records per the record query, a collection of records that meet the target query is assembled.

These records may be processed to implement national change of address (NCOA) correction, specific zip code removal processing (i.e., to remove prison code records), de-duplication and/or list merging and purging operations upon redundant or unwanted target records, and application of direct marketing association (DMA) opt-out data base entries. It is important to note that operations such as NCOA operations and DMA suppression may be performed anywhere before formal ordering of the lists (e.g., such operations may be performed upon installation of that list into the system). In addition, such operations may need to be re-performed periodically or occasionally as material in the DMA or NCOA databases, etc., change. After performing such processing, an end user may elect to have the assembled target records scanned and purged of any customer that the end user already has purchased from customer 12 in the past or is already incorporated into the end user internal customer data base (i.e., house files or pre-existing current customers already known by the end user). The computer 12 will provide to the end user or list broker counts and statistics on the target records obtained. For example, it will display the net records obtained, a total cost associated with using the assembled target records in commerce, gross names, balance names, new names and other counts and statistics associated with the records search of the selected lists. The total cost presented to the end user is a function of different pricing constructs associated with different lists contained in the database 20 of FIG. 1. For example, a first list may charge an end user $130.00 per 1000 names while another list may require that a charge of $120.00 per 1000 target record obtained be applied upon use with a net name or minimum payment guarantee of some fixed amount. Therefore, after individual records are pulled from individual lists, de-duplicated (i.e., de-dupped), and assembled, the total cost is calculated and any redundant records which are de-dupped by the system from two different lists are cost apportioned either in a fractional pro-rata manner or by round-robin or random assignment to a specific list. In another embodiment, costs can be apportioned according to criterion set forth by the end user. Any statistical information generated on the results of the search may be electronically or physically provided by mail, email, on-line access, FTP, or fax to end users, processing houses, or list brokers for subsequent review and approval. Either through on-line review or due to off-line review of communicated records, the end user and/or list broker may determine that refinement is needed to find a better final target list of customers in a step 216. If further refinement is needed due to cost reasons, improper selection of targets, inappropriate number of targets obtained, or other reasons, any one or more of the steps 202-216 may be executed iteratively and/or recursively as set for in FIG. 3. If quantity is an issue, a random deletion technique may be used to fractionally remove a portion of the list to carve the selected records down to a target number or target costs. Cost optimization algorithms can be applied to favor names from cheaper lists or to totally remove any losses associated with net name guarantees and minimum costs (e.g., $125.00 minimum on a list is expensive if only one name is picked from that list).

If no refinement is needed or if the end user or list broker is fairly satisfied with a particular search, that search query may be saved and/or archived by an end user or list broker for subsequent future use within computer 12. In addition, control is provided to an end user via steps 214 and 216 to randomly or intelligently trim a list of target records to focus the targeted list of selected records even further to a more targeted market for a particular marketing campaign.

Once a list of target records that suits the target criterion desired by end user is obtained, the end user or list broker enters a campaign key code in a step 218. The campaign key code is attached and/or associated with every target user record and every commercial use of every name within the final target marketing list. Through computer entry, barcode scanning, or manual entry of campaign key codes and information associated therewith throughout the marketing campaign, the end user, list broker, and/or computer 12 may monitor the return on investment (ROI) and/or the historical success rate of certain campaigns performed by the end user or list broker and feed these results into the database for use in future campaign selections and for historical processing purposes. Such electronic tracking of mailing, telemarketing, purchases, etc., by a consumer in response to a direct marketing event will allow the end user to determine the return on investment of his use of the target marketing list, and allow the end user to improve future generation of target marketing lists by archiving pertinent historical data for the end user. Using prior art techniques for direct marketing, this level of historical data collection, ROI tracking, and back-end processing was cumbersome for many end users where integrating such functionality into the on-line system has made such tracking operations more automatic, accurate, comprehensive, and efficient. In addition, sharing prospect customer data and other records information to and from other commercial systems for conducting analysis of data and customized customer interaction has not worked well to date, but seems to work well within this system.

In step 220, the end user or list broker will execute the order for the target or net marketing list and receive the list in a summary report of the target marketing list received via an electronic transmission, facsimile, U.S. mail, or like communication process. In addition to provision of the list in a step 220, on-line or off-line execution of legal documents via a step 222 is likely to occur. Also, the end user may be asked to provide certain information through the on-line system, such information being: intended use of the list; his identity; an example creative that will be used in his campaign; and/or like information. This information may be provided electronically or otherwise to the list owner and/or list manager for their approval. In some cases, a certain use of a list, a certain end user, or another factor will be offensive or objectionable to the list owner, whereby the list owner or his agents will be given the ability to prevent, not approve, or impose changes/restrictions in the provision and/or use of their information. If no approval or restricted approval is provided, the transaction may be changed or cancelled with the end user, or the end user is given the opportunity to continue or modify the transaction to avoid the information from this one or more non-approving list owner entities. Upon an optional execution of an agreement in step 222 and the end user's indication of ordering or acceptance of the list in step 220, the list is physically or electronically provided to the end user or it's agent via step 224. Upon receipt of the list, the end user may use the target customers received via computer 12 in commerce in order to perform telemarketing, directed mailing, or like direct marketing customer contact processes. Upon their use of such information, the end user will pay the price quoted by the computer 12 to the entity associated with computer 12, a broker, and/or the list owner and list managers set forth above.

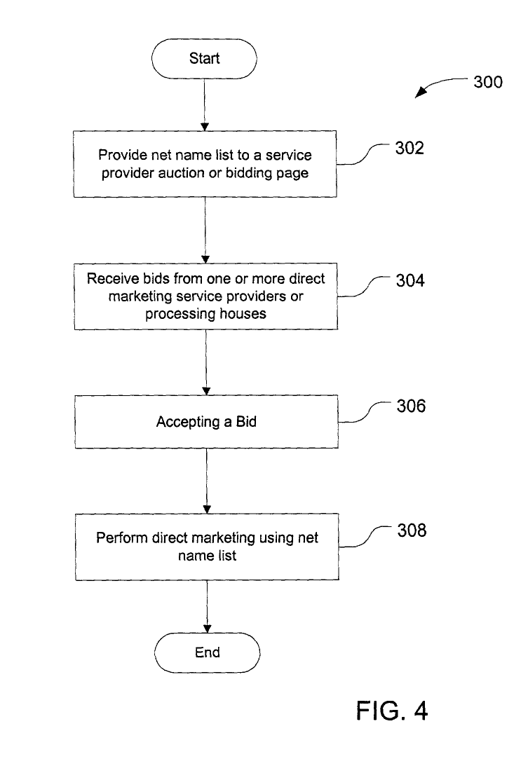

Once the processing of FIGS. 2-3 (using the system of FIG. 1) is complete, other useful operations may be performed by an end user. For example, FIG. 4 illustrates a method whereby an end user, after or while receiving/processing their list of target customers, may electronically post a direct marketing job request. This request lets direct marketing service providers (i.e., companies or individuals that have personnel, expertise, and equipment to perform a telemarketing campaign, printing, creative development, promotional product customization, or mass mailing for the end user) to electronically review and bid for the end user's upcoming marketing work. Therefore, FIG. 4 illustrates a method 400 that may be employed by an end user to locate service providers and optimize their expenditures when finding a service provider in the direct marketing segment.

Specifically, in FIG. 4, the end user orders his name list or begins processing his target direct marketing list using the process set forth in FIG. 3 or a process similar thereto. Once the end user is fairly convinced that they will perform the campaign, the user posts a request for service and/or the actual marketing list to a bidding page via a step 302. In step 304, many direct marketing service providers will review the material placed onto the bidding page by the end user. Information posted may be the size of the job (e.g., number of names), the desired cost range, the time frame in which the campaign needs to be completed, the type of campaign conducted (e.g., telemarketing, direct mailing, etc.), and any other information necessary or desirable for this bidding process. In step 304, any service providers that desire to obtain the business from end user will electronically post an offer that is then provided for review by the end user. In step 306, one or more offers from one or more service providers is accepted by the end user if an acceptable offer has been made. Once accepted, the marketing list derived from FIG. 3 may be electronically and/or automatically provided to the service provider so that the service provider may begin to process the names for direct marketing activity at the direction of the end user.

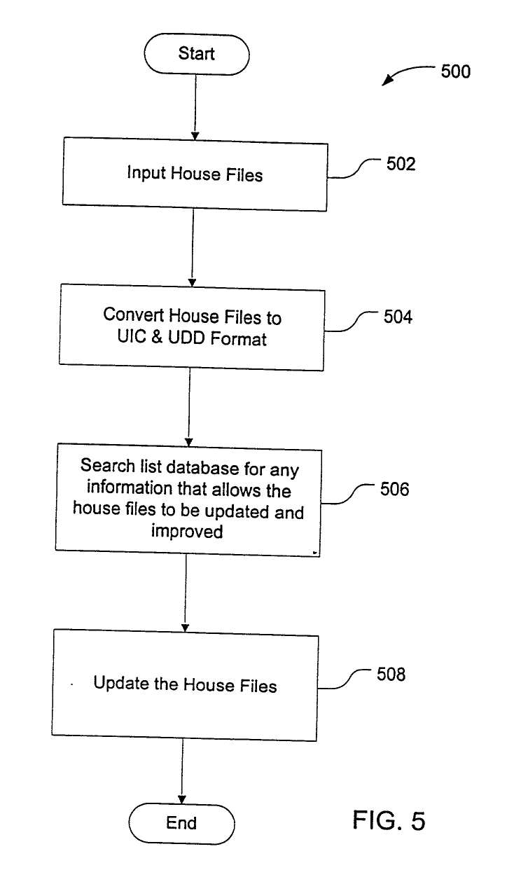

FIG. 5 illustrates yet another additional or add-on service 500 that computer 12 of FIG. 1 may perform for end users. In some cases, an end user does not want to find new customers, they desire to learn more about existing customers or correct their existing customer records so that they may sell more to existing customers and/or keep current customers happy and informed. Some customers will move from their home and it may take an end user months or more to determine that a move has occurred. In some cases, the end user may never be notified of the move. Buying habits of customers change. An end user may want to know of that behavior. In other cases, an end user that is a book store and also a CD music shop may want to know that one of their customers buys $500.00 of books from them per year but buys no CDs even though the customer is noted in a database as buying $1000.00 in CDs per year. The end user may use this information to determine why that end user is not buying CDs from his store and remedy that problem through customer surveys, investigation, information campaigns to existing customers, special offers, etc. The marketing lists stored in computer 12 may be used to accept an existing marketing list from and end user and correct, upgrade, add to, delete from, augment, or otherwise improve the end user's internal marketing lists (i.e., house files) in order to improve their service of customers and profitability.

Specifically, in FIG. 5, once the list of customers 20 in FIG. 1 is large and/or comprehensive, the end user may provide, as input to the system his house files or existing marketing lists in step 502. The house files are converted using the tables 26 of FIG. 1 to the UIC and UDD formats set forth in steps 110-112 in FIG. 2. In fact, if the end user so desires, the house files may be added to the bank 20 in FIG. 1 via the process of FIG. 2 in order to potentially generate extra revenue for the end user. However, some end users that use this function desire that their marketing lists remain as proprietary and confidential as possible.

After the conversion of step 504 in FIG. 5, the database 20 of marketing lists is searched to find UIC-tagged records that match UICs in the house files. If such records are found, these records are scanned field by field using UDD information in a step 506 to see if any customer information from the database 20 can be used to: (1) add new customer information for a specific customer from database 20 into a house record; (2) flag any information in a house record as being potentially outdated or incorrect and providing a potential correction of that record for acceptance by the end user; (3) find information that needs to be deleted from a house records since it is too old or inaccurate to be reliable going forward; and/or (4) perform any other useful data modification to the house file to improve that file's value to the end user. After such processing, the updated house file(s) are provided back to the end user per step 508 or made available in-line for end user needs and further analysis.

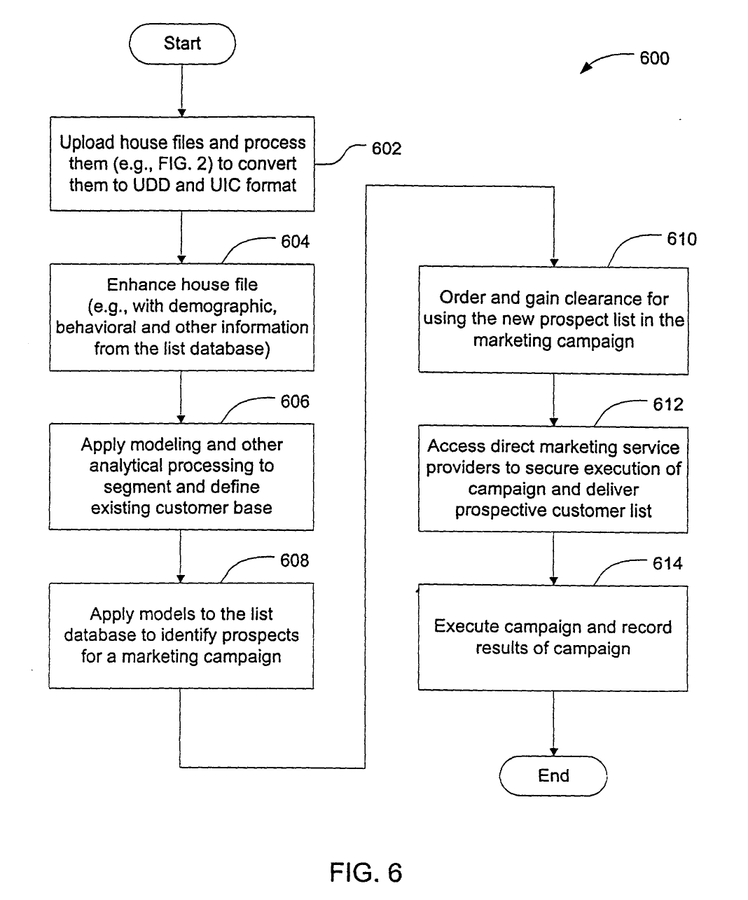

FIG. 6 illustrates an end-to-end method 600 which is commonly used among end users once they gain access to the system set forth in FIG. 1-5. In FIG. 6, a step 602 is used to receive house files (i.e., lists of existing customers) from the end user, and the step 604 is used to augment, update, correct, enhance, or otherwise improve the house file with information from the global list database. In essence, the steps of 602 and 604 are very similar or identical to the process of FIG. 5.

After steps 602 and 604, modeling and other analytical processing may be performed on the house files and any sales information provided by the end user per a step 606. In step 606, a list owner's house file, sales records, etc., will be scanned and processed to determine the demographic of a valued customer or customer segment. In other words, trends of what kind of person or business buys or doesn't buy product or services and characteristics or factors surrounding such sales can be identified. Once a successful demographic, characteristic, or mix thereof is found via such processing of the house files, a search that is tailor-made to find more such individuals may be generated manually by the user or automatically by the on-line system of FIG. 2. Such profile information is highly valuable to list owners and list end users since it allows for more targeted and value-added campaigning and ROI.

In step 608, the segments, models, and/or optimal customer demographics identified in step 606 is applied to the list database to find more customers that are statistically likely to be good future customers for the end user. Once, these prospective future customers are identified in step 608, a step 610 performed. In step 610, the end user may elect to use the intelligently gathered prospective customers in a campaign and may use the process of FIG. 4 in step 612 to secure a campaign service provider. Once a campaign service provider is secured, the campaign is executed per step 614. In step 614, campaign tracking, customer list modification, and more modeling or analysis may be conducted in order to improve the information previously provided or obtained in steps 602-612 whereby the process of FIG. 6 may be run again with iteratively improved results and possibilities.

The processes and systems discussed above in FIGS. 1-6 will likely use UIC and UDD methods in order to enable their operation. FIGS. 7-13 are used to describe, in more detail, the functions and implementation of the UIC and UDD portions of the system. UIC systems and processes are used to identify common records/customers across many different lists that were provided from one or many different sources. For example, the record for John Smith at 10 Main Street in Highland, Ind. may appear in twenty different lists from twenty different sources. It would be beneficial to have the commonality and location of these common twenty records readily available when searching via a UIC construct. The UDD systems and processes are used to ensure that all the lists may be responsive to a common language, search query, and interface. For example, the UDD processing ensures that a natural language request query for “in list A, B, and C find for me all males of age 25-30 years old” gives correct data regardless of differences across different lists, such as different data names/tags, data formats, data values, data structures, and the like in the lists A, B, and C.

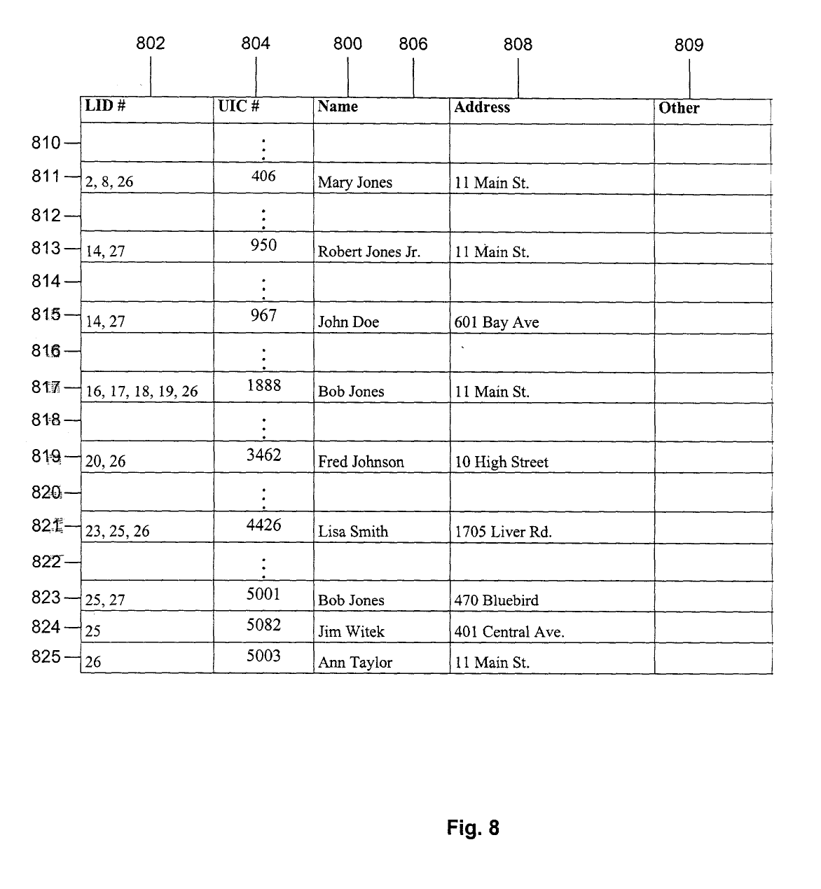

Specifically, FIGS. 7-9 are used to illustrated the UIC functionality of the system of FIGS. 1-6 (see specifically, step 110 of FIG. 2). FIG. 7 illustrates the UIC processing that would occur upon the receipt of three new lists 700, 702, and 704 in the system of FIG. 1. Since these list are not the first lists received by the system, a discussion of the current state of the machine, as illustrated by FIG. 8, is in order. Note that the system, at the time of receipt of these three new lists 700-704 of FIG. 7, has previously processed a plurality of prior lists and created UIC table entries for many previous customer records found in these prior lists. In our example, the number of prior processed lists is twenty-four. When these twenty-four lists were processed by the system, each list was likely given a unique list identifier or list ID number (LIN) whereby the first 24 lists were likely assigned list ID numbers (LINs) of 1-24. However, any numbering scheme, any other list ID scheme, or no numbering scheme may be used for lists as they come into the system of FIGS. 1-6.

Upon the receipt of the twenty-four lists (all at one time or spread out over time), the lists are scanned for common data records among the lists. In some cases, this scan of each record in each lists will find a record that as previously identified in another list. In this case, a UIC table entry or record already exists for that redundant record encountered in the new list, and the UIC table will only need to updated or checked in the table 800 of FIG. 8. New records/customers, never before seen by the system, are assigned new UIC numbers and new entries in the table 800 of FIG. 8 are created therefore. The result, from scanning all of the twenty-four lists, is shown as the UIC entries 810-822 of FIG. 8. Note that it is not uncommon for hundreds of millions of records to eventually be present within the system taught herein. Therefore, these UIC tables may become very large, and known, yet complex, data structures may be implemented in order to make maintenance and access of these many records more efficient. Therefore, other data constructs or structures other than tables may be used herein (e.g., trees, hash tables, etc.).

With this starting environment already established, the lists 700-704 of FIG. 7 are received as input lists by the system. Since each incoming lists is given a list ID number (LIN), the data card number or LIN for list 700 is assigned to 25, list 702 is assigned to LIN=26, and list 704 is assigned to LIN=27. These IDs are generally sequential and numerical but need not be of this form or function. For example, each lists may have a unique alphanumeric code designed to ID an owner or source of the list, and many other LIN constructs are possible and useful. In any event, the list ID numbers (LINs) are generally used to identify specific lists during list broker and manager operations that were discussed in detail above per FIGS. 1-6.

Once the LINs are assigned, each list 700-704 in FIG. 7 is scanned in order to determine if the customer records in each list are new customer contacts never before encountered by the system, or customers that had been identified in previous scans of other lists. In some cases, it may be best for processing efficiency if two alphabetical link tables are created. An array of pointers, the link table, may be set up to alphabetically sort (or update dynamically in alphabetic order as lists come in) the records within the list to be processed (e.g., one of lists 700-704). Also, instead of an unalphabetized list that is rendered alphabetized by an array or pointers set in alphabetic ordered links into the unalphabetical table of FIG. 8, the UIC table itself may be kept in sorted. Once alphabetized or categorized in some other manner (preferably in a manner that does not destroy the original state of the list), it is easier to search the new list records of an incoming list against the existing entries in the UIC table 800 of FIG. 8. Therefore, alphabetizing of the table of FIG. 8 and/or the incoming list of FIG. 7 in some temporary or permanent manner will assist in UIC processing operations.

In any event, assume list 700 of FIG. 7 is first selected for UIC processing and that this list in not sorted or tampered with at all, but the table of FIG. 8 is sorted by a separate alphabetical link table of pointers. The first record 710 of list 700 is first picked for processing since one way to processes the lists to assign UIC numbers is to take the records in order from the lists 700-704. Using the name of the customer, the address, and potentially other information (e.g., age, etc.) from the record 710, the data of record 710 is compared to the entries of table 800 of FIG. 8. Such may be done against the data FIG. 8 by binary searching, sequential scanning, or any other exhaustive method of record access and comparison (an alphabetized FIG. 8 of some form assists in this operation). After a scan of the table 800 of FIG. 8, it is determined that no record currently exists in FIG. 8 that is analogous to, related to, or equivalent to the information of record 710 in FIG. 7. Therefore, a new UIC entry in FIG. 8 (e.g., entry 823) is created in FIG. 8 and the information from the record 710 of FIG. 7 is copied to that entry 823. Common information copied or provided in order to create a record in table 800 of FIG. 8 is: the one or more LINs 802 from which the record may be traced back to a specific list (or even an exact location, position, or address within a specific list), the unique assigned UIC number 804, a name 806, an address 808, and any other useful information 809 whereby a new UIC data table entry is created.

With record 710 now recorded as a UIC entry with a new UIC code of 5001, the process then moves to process the next record 712. A scan of record 712 against the table 800 of FIG. 8 determines that the same Lisa Smith has been processed in a previous list and has already been assigned a unique UIC record in FIG. 8. Therefore, the existing record in FIG. 8 (e.g., entry 821) for Lisa Smith is updated to include the new list ID or LIN, and the process continues on to the next record. It is important to note that the recognition of a previously existing UIC may result in execution of a sub-process, either at that time or at a later time, where data from the same customer records are compared to ensure correctness of information, and the maximal amount and completeness of information across all the records. For example, if two records indicate different information, like two dependents versus three for Lisa Smith, the program may be prompted to flag and/or try to remedy that inconsistency or availability of potentially more up-to-date information. Further, if the list 25 of FIG. 7 has Lisa's age and the list 23 (which previously was found to have Lisa's information contained therein, see entry 821 of FIG. 8) does not contain such information, then data structures can be implemented to link the list 23 to the additional age information on Lisa in other lists (e.g., see house file update processing in FIG. 5 for example).

Next, record 714 is scanned and found to contain a new customer whereby that customer is assigned the new UIC entry 5002 whereby Jim Witek will be processed as UIC=5002 in all subsequent transactions. All information for that customer, like name, address, etc., is placed into the table 800 of FIG. 8 whereby a new record 824 is created.

In some rare occasions, the same list may have duplicate entries. For example, in FIG. 7, the process discovers that the record 716 and the record 710 in the list 700 are duplicates. Duplication can be handled in one of many different ways. In one form, the records 710 and 716 are compared on a field-by-field basis to ensure accuracy and completeness of data in at least one of the two redundant records, and then one of the two records is removed or de-duplicated from the list. Such a process of record comparison continues through all of list 700 of FIG. 7 until all names/records from that list have been UIC processed and assigned a UIC (either new or existing) in some manner.

After processing of list 700 is complete, list 702 is processed. In list 702, the first record 718 indicates why more than just a name is need to ensure that UICs are properly assigned to records. In record 718, the name Bob Jones is once again encountered (see records 710 and 716). However, comparison of other fields in the record indicates that this record is indicative of a customer previously found in lists 16-19 (see FIG. 8) and not the customer Bob Jones found in records 710 and 716 of list 700. Therefore, this record 718 is assigned the UIC 1888 previously existing in table 800 of FIG. 8. Note that the entry 817 is updated so that the table 800 reflects that this Bob Jones has once again been found in the list 26 in addition to lists LIN=16, 17, 18, and 19.

Processing of list 702 continues with record 720 being determined to be an old UIC, whereby record 720 is associated with record 819 of FIG. 8 and assigned the UIC of 3462. Record 722 is not found in any UIC entry of FIG. 8 whereby a new UIC entry 825 is created for record 722 of FIG. 7 and record 722 is assigned the sequential unique UIC value of 5003.

Record 724 of FIG. 7 presents an opportunity to discuss other codings, other than or in addition to UIC, that may be optionally used in the system of FIG. 1-6 to enable more comprehensive and effective searching. The process, for record 724, will assign a UIC of 406 since that is the UIC already assigned to this customer per FIG. 8, entry 811. However, the process may enhanced to recognize that the address or homestead of Mary Jones in record 724 is the same as the homestead of Bob Jones in record 718 of FIG. 7. In the alternative, post processing of the UIC table 800 may determine the same conclusion. In any event, the two people at the same household or living address may be assigned a household ID code or HIC via the table of FIG. 8 or yet another table. The indexed and/or tabled HIC values may be used in marketing campaigns to only provide a single creative or single offer per household, and then within the household may target a specific demographic or family member in the household. For example, rather than sending central air conditioning offers to each of the 5 members in a household (three being minor children), one may choose only to send that offer to the most senior male or female member of the household. Such targeted household marketing is possible with the optional HIC assignment scheme discussed above.

The introduction of the HIC, in addition to the UIC, enable some powerful and effective searches for end users in a way that will maximize return on investment (ROI) by rendering a marketing campaign more appropriately focused. HIC is not the only custom or focused UIC code that may enable such a result. One could also implement a business ID code (BIC) that identifies all individuals working for the same company, at a same factory or office, or in a same professional field. ID codes may be used to identify all people with a certain title (e.g., all CEOs or medical doctors worldwide). ID codes can be used to geographically split the customers records or identify certain business records that have international marketing chains. In essence, almost any type of characteristic among lists and list records may be used to commonly identify and categorize certain records or class of records as falling into a common category.

Returning to the detailed discussion of FIG. 7, the processing of list 702 will eventually end, whereby list 704 will then be processed per the algorithms and rules discussed above. Eventually, all the records within FIG. 7 are assigned to UIC values (either new values or pre-existing values) and any additional ID codes (e.g., BIC, HIC) that are enabled in the system are also assigned. The result is a table 8 of assigned UICs that may be accessed during the searching of certain lists to improve and speed list processing for end users, brokers, owners, and managers. The UICs are especially useful in de-dupping multiple customers from a lists generated by a search of multiple lists and for aggregating customer information across many different quickly-identified sources. As an example of de-dupping, a search for a marketing campaign intended to target people who watch a lot of TV may result in the retention of both the Bob Jones records 710 and 730 of lists 25 and 27 of FIG. 7 and both of the Lisa Smith records 712 and 726 of FIG. 7. These collective four records do not represent four individuals as would appear from a record count, but really two individuals. The UIC may be used to recognize that overlap or duplication, and remedy that overlap by de-dupping operations that are performed before the list is ordered by the end user or his agent(s)optional.

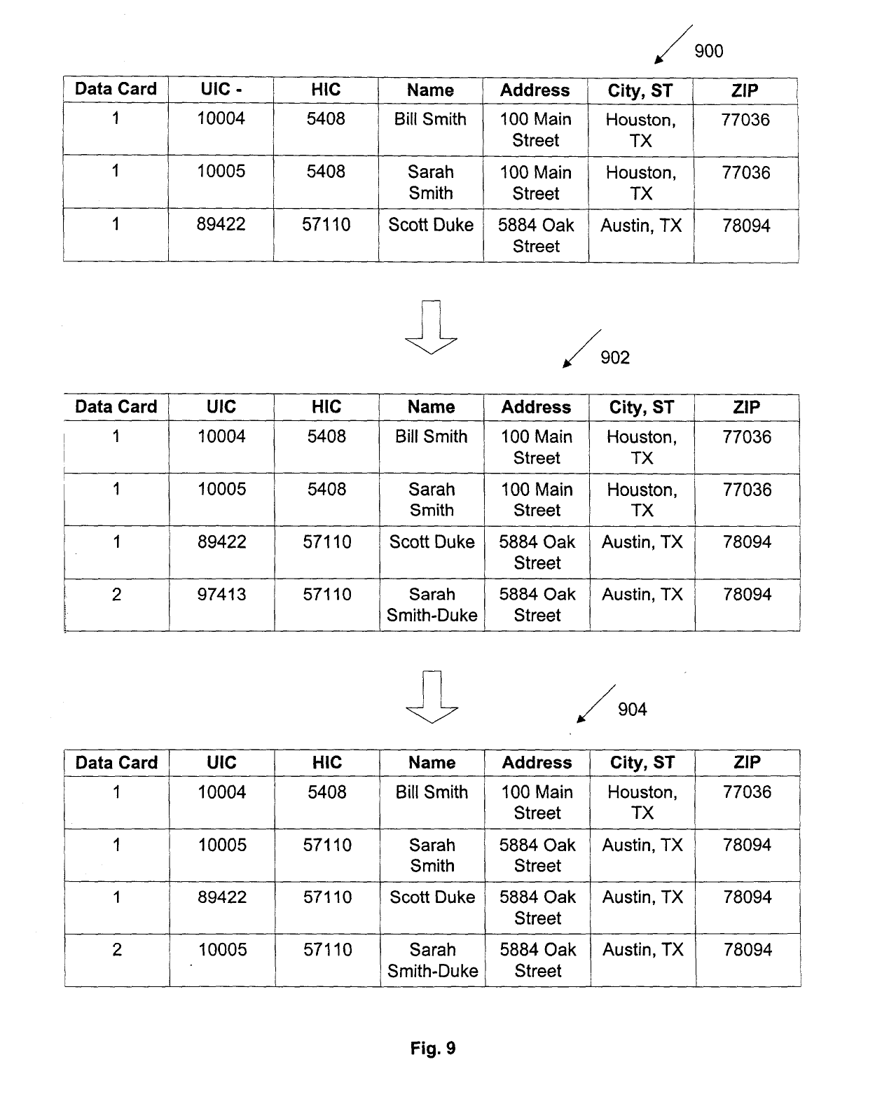

FIG. 9 illustrates in more detail how the ID process discussed herein may function to update information over time as new lists come into the system. Specifically, FIG. 9 addresses by way of an example the use of the optional IDs that are sub-ID values to the general UIC (e.g., the HIC in this specific case, or the BIC as another alternative). FIG. 9 illustrates a UIC table 900 that initially has three record entries created via receipt of a single list/data card. Note that the first two records have been identified, per the algorithm discussed above in FIGS. 7-8, as being in the same household whereby a common HIC has been assigned to these records. In FIG. 9, a middle UIC table 902 is illustrated as being table 900 with added data due to the incoming names/records from a new list/data card having a LIN or data card ID number of 2. All new lists and all the names/records within the database are periodically run through the national change of address (NCOA/Fast-Forward) process. If this example table 902, no changes resulted per the NCOA process. In addition, the new entry from list 2 does not match any existing UIC records. Therefore, the new entry of Sara Smith-Dude is assigned a new UIC and her HIC is set per her address as illustrated in FIG. 9.

After a period of time, or upon receipt of new list information, the NCI process is performed once again. This time, the system discovers that Sarah Duke-Smith has moved from one address to another address whereby two records in the UIC table are now found to be indicative of the same person. In this case, the lowest UIC is maintained and the information between the records is compared and updated to ensure proper information, and then one duplicate record may be removed from the system. Once a record is moved from a current HIC to a new HIC, the old HIC conversion to the new HIC conversion is maintained in a running history table so that residence changes over time may be tracked and used for marketing purposes. The above example is also indicative of the UIC updating scheme that may be used for other codes such as the BIC or like IDs.

In the event that a move has occurred, but the NCOA database does not reflect such a move, there may still be a way to correct the information in the database of FIG. 1. This is definitely the case when a marriage or change of surname has occurred with a change in address. The change could be detected using social security number monitoring if such field is present in the database lists in issue. However, in most if not all cases, the NCOA database is eventually updated with the proper information whereby the need for social security processing is not always necessary, but available for general use if the need arises.

Generally, the UIC, HIC, and other ID codes are set using the address, site of business, name, and like fields. However, any one or more fields may be used to configure and maintain a specific ID code and table. Generally, the HIC, UIC, or other ID codes are 4-bytes or more in length, whereby billions of unique codes may be maintained, archived, and processed over time. Once an ID code is used/assigned in a preferred embodiment, it should never be reused or assigned to another entity or individual to enable historical and accurate tracking of all information resulting within the system of FIG. 1. To ensure that ID codes never run out, large values may be assigned in a system that does not allow reuse of ID codes. Systems, like HIC or UIC counters and place-holders may be used to ensure that unique ID codes are assigned and the duplicates are not created. Regardless of implementation, codes associated with records and names, that categorize records into a common rubric, are very useful in direct marketing list searching and ordering.

In addition to UIC and other ID processing performed on direct marketing list records, each data field/name/tag (e.g., birth date), data types, data ranges, and data formats (e.g., mm/dd/yy or mm-dd-yyyy) within each data item of a record may vary from list to list. In essence, purchasers of marketing lists have no current way to search for and select names across multiple list databases in a manner that is common and seamless. List databases employ unique field names and data values/ranges, group field populations into unique segments, utilize dissimilar data nomenclature (e.g., one list may use “address” versus another list using “residence” for the same information). In addition, this data may have different data structures, formats, or data types that are used to store such information. It is not uncommon for marketing lists to be derived from a company's internal proprietary customer database where the lists differ significantly based upon the source application and historical development of internal data structures. Learning different nomenclature, data formats, and the like for each list in order to be ready to search all lists is not optimal, and not being able to easily search all lists with common queries can get expensive, time consuming, and even inefficient in terms of missing certain data due to a bad search. Therefore, lack of standard queries, structure, formats, and queries is problematic for a list aggregation system, as set forth in the above discussion of FIGS. 1-6, where multiple lists from multiple source are aggregated with the idea that these lists will be processed with a common and seamless interface while still preserving the original content and format of the incoming lists as much as possible. In order to overcome data discrepancy problems, a standard database format must be forced upon all the lists, preferably in a non-intrusive or non-destructive manner, to allow for standardization of the list information across all lists.

In addition, purchasers wanting to manage and analyze multi-database purchases and usage must purchase data on a segment-by-segment basis on each list in order to translate database fields into common data segments. Due to the inefficiencies of purchasing in this manner, many purchasers forego the potential benefits of data aggregation. In fact, many purchasers get lost by the lack of uniformity and live with general, imprecise selections across data segments in different lists. In some cases, many purchasers determine their target prospect audience based upon intensive, expensive profiling, modeling and analysis of internal customer records only to discover that the results cannot be applied to the marketing list population available for purchase due to nonuniformity across lists. Also, list sellers do not make data files, with all list records, available to purchasers to investigate underlying data field contents for translation and matching to desired criteria. Accordingly, purchasers must choose list segments on a limited list-by-list basis and learn data field names, data structures and data nomenclature across the list universe, even when the underlying data and formats in the lists may (or may not) be similar. The uniform data dictionary (UDD) is used to remove, or at least soften, the adverse effects of non-standardization across lists and list data fields. The UDD allows for researching across disparate data structures, allows purchasers to search entire list populations at one time with the same query, and allows a user to be confident that the returned search data is more complete and accurate than previously available. Once lists containing uniform field names, types, and values are identified, purchasers can apply field attribute criteria across the selected list population.

To facilitate this common search methodology for all lists, file databases are analyzed once upon first provision thereof into the system of FIG. 1. With this incoming analysis, a common UDD field for each record field is appended to each file record or, in a preferred form, formulated in a separate array of UDD processing tables. This use of one or more separate UDD tables or like data structures to translate a list into a common list scheme is preferred since it is generally prudent to keep the original direct marketing lists in tact, as provided by the list owners/managers, so that cross-contamination of lists is not likely, lists can be easily purged from the system if need be, and/or attribution for certain information can be clearly maintained. Regardless of specific implementation, once the UDD processing table(s) are created and applied across all available lists, the purchasers need only to learn the standard UDD language for common fields such as age, gender, title, business, market share, number of children, etc., in order to perform a comprehensive search of all relevant lists regardless of the list's source, structure, and content. In addition, by using the uniform data dictionary (UDD), purchasers can perform quick and comprehensive modeling, profiling, and analysis on large numbers of lists and directly apply results of such processing to the marketing list population in its entirety or in sub-segments as chosen by the end user to further focus marketing efforts.

In more detail, the UDD process and resulting data structures are set forth in FIGS. 10-13. The FIGS. 10-13 generally describe the process that is occurring in step 112, of FIG. 2. Specifically, FIG. 10 illustrates, in a flow chart, a method 1000 that may be used for process a list from an incoming format to the common UDD format. In FIG. 10, the first step in the process is to receive a direct marketing, house file, or prospective customer list via a step 1002. After the list is received, the list is scanned in step 1004 to obtain a lists of the data field names or data tags within all of the data records. For example, each record in the list may contain the following eleven field names or data values: first name, middle initial, last name, street, city, state, zip code, age, home phone number, work phone number, and email address. Another list may contain the following nine data field names or tags: company name, company address, employee name, title, salary, grade level, manager's name, active employee, and work division. The step 1004 is used to identify all of these field names or tags in each record of the incoming list.

After step 1004 is performed, a step 1006 is used to scan a single record (or all or some subset of all of the records if all of the records are not identical in format) to determine the type of data, as well as the types of values, that are placed into each data field identified in step 1004. Some fields may be alphanumeric character strings, some fields may be integers, some fields may be yes/no (y/n) values, some fields may be dates, some fields may be floating point numbers, and so on. Once the type is known, step 1006 then determines the range of values or formats that are possible for each data field tag/name. For example, the tag “age” in each record may be entered in a range field where the possible assigned range values are <20, 20-29, 30-39, 40-49, 50-59, and >59; or date may be stored as Dec. 17, 1978 or 12-17-78 or 12/17/1979, etc. Step 1006 is used to identify these different data types, values and formats so that complete conversion tables may be generated for all lists, all data tags/names, and all data types/values/formats across all lists.

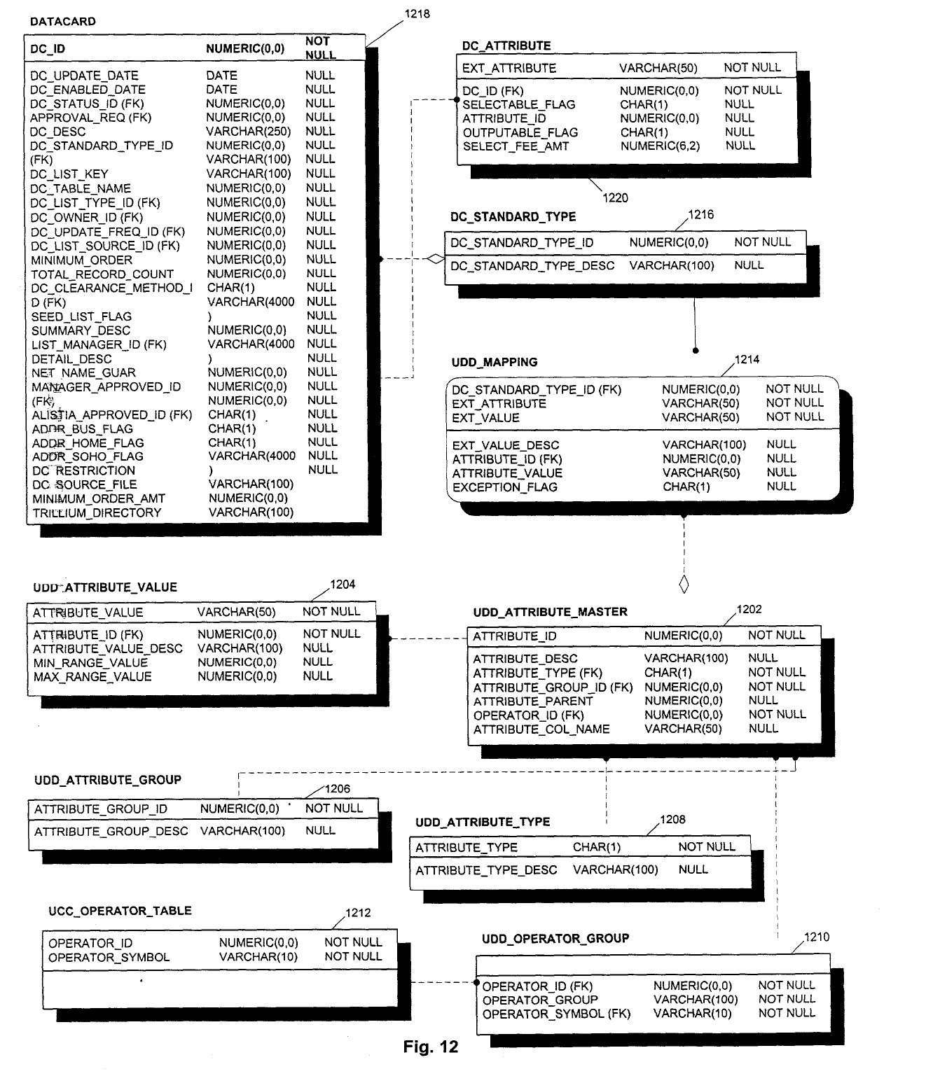

After general identification of the list data and structure per steps 1004 and 1006, step 1008 is used to determine if the existing UDD processing tables have the data name/tag information already present. For example, another list may have already contained the data tag “name” and been placed into the UDD processing and conversion tables (the specific construct of these tables are discussed in more detail in later figures, e.g., see FIG. 12). In some cases, a data tag name will not identically or closely match a field already present in the UDD processing tables, but will fit a profile already existing in the UDD processing tables under a different identifier. For example, “last name” may not be found in the UDD tables, but “surname” may already be present whereby the last name tag can be converted to a surname tag (or vice versa) to obtain a common data tag for that searchable characteristic. Such recognition of common but not identical tags or names may be performed by the computer or may need human intervention to recognize and set up for the first time. Nonetheless, relationships between common names and tags may be build into the system over time as more and more lists come into the system. In other cases where the name does not match any existing name or tag in the UDD constructs, the receipt of this new name/tag may be the first time this field was ever encountered by the system of FIG. 1. In these cases, a new profile or entry in the UDD processing tables is created to accommodate current and future conversion of that data to the standard searchable format.

After a data name profile or record is found or created within the UDD processing tables, the UDD table is scanned to ensure that all possible UDD values and formats found within the current list are accounted for and adequately mapped in the current UDD tables via a step 1010. For example, even though “age” of type “integer” is present within the UDD table, this new list may be the first list that has an age category for age greater than 100 years old. In this case, the existing age constructs in the UDD tables need to be enhanced to accommodate this new possible data range or value in the “age” tag/field. In many cases, the processing of previous lists has resulted in an exhaustive or adequate set of potential data values and formats whereby no new formats or values are found within the current list. Usually, the processing performed in step 1010 will not result in the addition of new profiles or records in the UDD tables but will enhance or expand existing entries in the UDD tables. In addition, this process allows UDD records to be enhanced to handle additional data granularity. For example, if an existing “salary” field only had ranges of $10 k increments and the new list coming into the system had ranges of $1 k increments, this more granular identification of salary may be coded into the system to enable more finer salary search results rather than forcing the data in this list to the less granular $10 k-sized ranges.

After the UDD processing tables are created per steps 1008-1010, step 1012 is used to process the list against the UDD processing table in order to create a UDD mapping table or UDD conversion table. In this step 1012, a table is built that allows each data field/tag and data value or format within the list to be quickly and dynamically translated into the universal search language used by the direct marketing lists system of FIG. 1. By way of example, assume a list has “sex” as a field where a scan of the list has determined that the exhaustive possible values for “sex” are “m” or “f” in that list. Assume also that the existing UDD conversion table has a field “gender” that contains either “male” or “female”. It will be determined by a relational or historical database or human intervention, that the “sex” field is the same as or overlaps substantially with, the existing “gender” field. Therefore, the UDD table will be created such that any search query of the lists using “gender”, such as “find gender=male” will search not only the gender fields in other existing lists, but will search the “sex” field in this list for the records containing the values “m”. In other words, when doing the search, the UDD conversion table will ensure that every “m” that is found in this “sex” field is equated to “male” resident within the global “gender” search field. In this manner, many different lists with different tags, fields, values, types, etc. may be converted to respond accurately to a common search language or query.

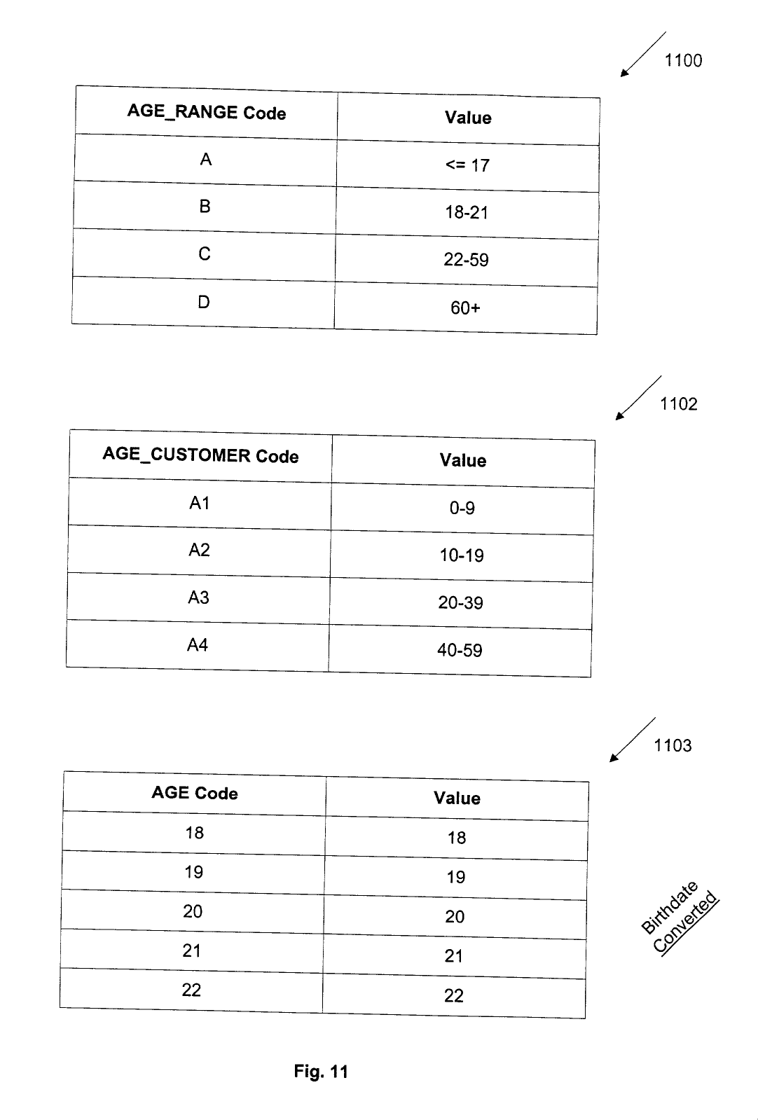

As an example the performance of the process of FIG. 10, FIG. 11 is provided. FIG. 11 illustrates, in a much simplified format, the results of the processing of steps 1004-1006 of FIG. 10 on three lists 1100-1004. In FIG. 11, all of the lists 1100-1104 contain a data field/tag related to “age” information. The first list 1000 has a data field name or tag as “age_range” and has four possible values of “A”, “B”, “C”, and “D”. Assume that the age range codes are such that A is indicative of a person less than or equal to the age of 17, B is indicative of a person within the age range of 18 to 21, C is indicative of a person within the age range of 22-59, and D is indicative of a person greater than or equal to 60 years of age. The second list 1002 has a data field name or tag as “age_customer” and has four possible values of “A1”, “A2”, “A3”, and “A4”. Assume that the age range codes are such that A1 is indicative of a person of age 0 to age 9, A2 is indicative of a person within the age range of 10 to 19, A3 is indicative of a person within the age range of 20 to 39, and A4 is indicative of a person within the range of 40 to 59 years of age. The third list 1004 has a data field name or tag as “age” and has five possible values of “18”, “19”, “20”, “21” and “22”. Assume for this last list that the age range codes are such that these alphanumerical ages are identical to the numerical ages of the customer in that record. This information is the information that is scanned and extracted from the list on a record-by-record, and field-by-field per steps 1004-1006 in FIG. 10.

The extracted information of FIG. 11 is usually placed into a UDD processing data structure of the format shown in FIG. 12. While FIG. 12 does not show the specific data from the “age” example of FIG. 11, FIG. 12 was used to show the complexity of the UDD data structure solution in general. After processing just a portion of one list, complex linking of various different UDD tables or constructs are in existence so that there is a quick and efficient data structure for translating data tags/names, values, ranges, types, etc., to a common search format.

The method for forming the UDD constructs of FIG. 12 may vary widely and yet have the same end result. In one embodiment, when a new data field name or tag is identified or needs to be converted to a standard name/tag, that new data field name or tag is placed into a UDD_Attribute_Master list/table. The UDD_Attribute_Master list/table is shown in FIG. 12 as the table 1202. Generally, the table 1202 is a list of field common names/tags generated for use across all of the lists so that if these tags are ever encountered again for subsequent lists, that tag in the lists may be quickly placed into a conversion table for uniform mapping of the list upon a search event. It is this list of search terms that the end user focuses on when performing direct marketing searches, most (if not all) of the other information in the FIG. 12 is preferably hidden from the end user. In addition to table 1202 containing the uniform search name, the table may contain a few optional table entries that may identify certain things like its type (is it character, numeric, date, etc.) and other characteristics of the common search name/tag. In addition to some of this information in each entry of table 1202 is an array of pointers associated with the tag entry that allows the tag/name to be associated with other characteristics, tables, or profiles shown in FIG. 12. In essence, the table 1202 defines the set of field names/tags that may be searched by an end user and provides links to other data structures or tables that expand upon or augment this information or the use of this information.

Once the universal field names or tags are set in table 1202, it is useful to map these fields to the array of possible values through pointers stored in table 1202. To enable such definition of values and ranges, the UDD_Attribute_Value table 1204 is formed to hold, for each name in the table 1202, all the existing possible values or ranges that can be associated with that field name/tag. For example, the value “married” in table 1202 may only point to two possible value entries in table 1204, one for “yes” and one for “no”. However, the “age” field from list 1104 in FIG. 11 would require five entries in table 1204 by way of example. Therefore, the table 1204, via links/pointers to table 1202 allows all the universal name/tag fields in table 1202 to be associated for searching and processing with all its possible values and formats.

In FIG. 12, data may be arranged in a hierarchical manner. For example, address, city, state, and zip may be arranged hierarchically to form a “residence” field. The residence field may be combined with phone numbers and email to result in yet another hierarchical construct called “contact information”, and so on. The table 1206 allows the system to construct, track, and search based upon this type of hierarchical organization of the data. Each single entry in the UDD_Attribute_Group table 1206 is mapped into one or preferably more than one tag/name in table 1202 or previous defined hierarchical construct in table 1206 to create this complex hierarchy between one or more data field names/tags.

Each common field name/tag/attribute in table 1202 has some sort or format or data type. Some are integer, some date, some y/n, some alphanumeric string, some range, some finite list, etc. The UDD_Atribute_type table 1208 in FIG. 12 sets forth, through a pointer link to the table 1202, the data type of each field in the table 1202.

Each entry in the table 1202 may be searched by a specific set of rules. For example, for an integer data field, one may want to search data using the values of: greater than, equal to, less than, negative, positive, zero, or like search criterion. For a string data value, one may want to search such data using constructs such as: begins with, ends with, contains, equals, does not contain, etc. The UDD_Operator_Group table 1210 sets forth the group of operations that are available for querying or searching with that particular field within the table 1202. In addition, the UDD_Operator_Table 1212 allows the data structure to assign a group of common operators that enable such search constructs. For example, table 1212 may specific that for “age” in table 1202, one may search that field using operators such as >, <, =, <=, and/or >= which represent the operation of greater than, less than, equal to, less than or equal to, or greater than or equal to respectively in table 1210.

Referring back to the example in FIG. 11 in relation to the discussion of FIG. 12 above, the table 1202 contain the names/tags/fields which may be searched in the list. Therefore, using the age example in FIG. 11, FIG. 12 may create the standard age search term (or UDD Code) “Age_std” in table 1202. From the three lists 1100-1104, the system can determine that the exhaustive lists of values possible for the “age” field (13 possible values in the case of FIG. 11) and place thirteen entries in table 1204. Also, age may be flagged as an integer in table 1208. Further, age may be searchable on all the typical integer operations and symbols as set forth in tables 12010 and 1212. However, list 1100 uses “age_range”, list 1102 uses “age customer”, and list 1104 uses “age” to identify the “age_std” universal tag set forth in table 1202. To make this correlation of list tags and names to the UDD assigned tags and data in the tables 1202-1212, the UDD_Mapping table 1214 is needed. The table 1214 maps the different tag/names used in each actual list (e.g., “age_range”, “age_customer”, and “age”) to the universal search term (e.g., “age_std”) in table 1202. In addition, table 1214 will contain entries that allow each data format, value, or range in that field to be mapped appropriate to the universal search information.

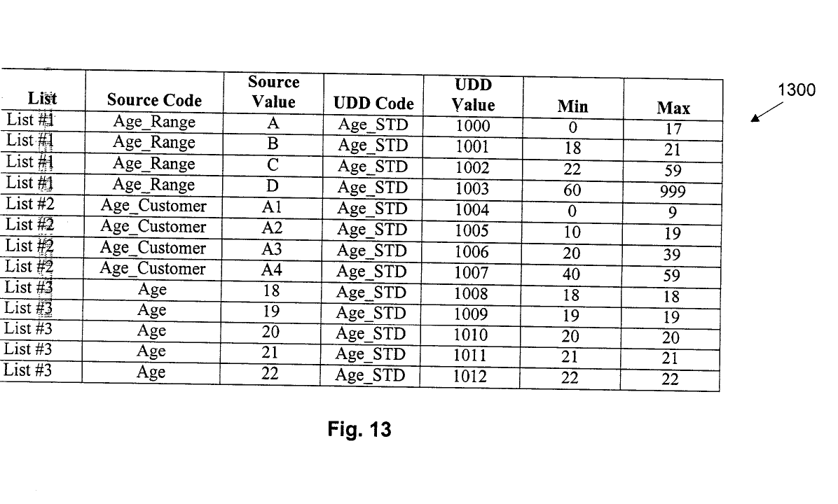

In order to better understand the creation of table 1214 of FIG. 12 and its purpose, FIG. 13 is provided. In FIG. 13, a UDD_Mapping table 1300 (analogous to table 1214 of FIG. 12) was created for the age examples set forth in FIG. 11. In FIG. 13, each entry is created to map the standard UDD code from table 1202 of FIG. 12 to the actual field name/tag in the physical/actual customer list. For example, rows or entries 1-4 of FIG. 13 map the actual field “age_range” in list 1100 to the universal search UDD term “age_std” in table 1202 of FIG. 12. Rows 5-8 of FIG. 13 map “age_customer” from list 1102 of FIG. 11 to “age_std” of table 1202 of FIG. 12, and rows 9-13 of FIG. 13 map “age” from list 1104 of FIG. 11 to “age_std” of table 1202 of FIG. 12 to enable universal search translation.

In addition, a new entry in FIG. 13 is created for each of the possible value within the field/name upon recognition of that new value or possibility as time goes on and either lists are received or existing lists are updated. List 1100 in FIG. 11 had four values, so it has four rows/entries in FIG. 13. By way of comparison, list 1104 had five values, so it has five rows/entries in FIG. 13. If any of these values would be the same, they may would share the same entry in table 1214. Therefore, by having table 1300 of FIG. 13 (same as table 1214 of FIG. 12) containing fields such as list ID, source code field/name, source value from original list, UDD universal code, UDD universal value, types fields (e.g., min and max for ranges), and/or other fields, the UDD terms of table 1202 of FIG. 12 may be mapped to actual list constructs and data in a dynamic and efficient manner.

Now that the table 1214 is understood, it is noted that table 1214 may contain entry pointer arrays to one or more other sub-tables. By way of example, list ID values may not be placed within the table 1214 but may be linked into that table via there presence in a separate table 1216 of FIG. 12. The summary information and field identifiers for the data lists are present in the Data Card Table 1218 of FIG. 12. The data card, its contents, and its purpose were discussed in detail with respect to FIGS. 1-6 herein. In addition, some data card information or data field names/tags may be searchable and accessible to the end users while other certain information is selected as non-searchable to protect confidential information, customer privacy, comply with sovereign laws, etc. The table 1220 of FIG. 12 is used to designate which fields of the lists are searchable and which fields are not searchable. In addition, this field may be used to determine which record data is secured or protected to a greater degree (e.g. by encryption, firewall, password protection, system monitoring, separate server storage, etc.) and what information is given less protection from intrusion, tampering, and detection.

Given the above discussion of FIGS. 10-13, it is now easy to discuss what would result if an end user were to search the age information in the lists of FIG. 11 using the master term “age_std” in table 1202 of FIG. 12. For this discussion, assume that table 1214 of FIG. 12 looks like table 1300 of FIG. 13. If the end user enters “find age_std<25 in all lists” the system would scan the tables of FIG. 12 (especially tables 1202 and 1214) and determine that UDD values 1000 and 1001 from list 1100 satisfy that search criterion since all of the records in those categories are certainly within the bounds of that search request. This was determined by accessing “age_std” in table 1202 and using sub-tables, such as table 1214, to find the desired data from the actual direct marketing lists. However, even though some of the records in UDD value 1002 of FIG. 13 would be less than 25 years old, the database cannot be certain that all or any part of this data would be in such a range, so these records are left out from the search results. Note that this selectivity may be programmable in the system so that the end user may select that we want only the data that is certainly within his query or all the data that may be within his target query. For this same search with respect to list 1102, the system would return all records associated with UDD values of 1004 and 1005 as set forth in FIG. 13. For list 1104 in FIG. 11, the search “find age_std <25” would return all of UDD values 1008, 1009, 1010, and 1011 since the system would be certain that all those records contain individuals under the age of 25.

Similarly, a search of lists 1100-1104 (see FIG. 11) and the data structure of FIGS. 12-13 using the search “find age_std>50” would only return the UDD value of 1003 since the records associated with this UDD value are the only records that the system can guarantee all have that search attribute. As a final example, a search “find age_std=21” would only return records associated with UDD value 1011 from list 1104 of FIG. 11.

While the direct marketing embodiments and UIC and UDD methodologies, constructs, and systems are taught herein and have been illustrated and described herein with reference to specific implementations, further modifications and improvements will occur to those skilled in the art. For example, the computer 12 may be controlled by the entity that created with software resident in memory 14, however, the creator of the software may also use an application service provider (ASP) model where the software is resident, supported, and operated by a third party on a third party computer system. In addition, the person controlling the system of FIG. 1 may reverse ASP or install and support add-on customer applications on the system of FIG. 1 for more integrated and seamless use of multi-party software on one platform. The process taught herein may be offered as a service bureau where the party creating this solution provides data processing and online services. A service bureau solution may offer a variety of additional software packages, batch processing services, data entry, etc., as well as custom programming and development for end-users. With a service bureau, customers pay for storage of data on the system and processing time used, and connection may be made to the system via dial-up connections, private lines, the Internet, frame relay, secure connection, wireless protocol, other WAN services, or like communication methods.

In addition, the process taught herein may perform modeling and analysis that was not previously possible after execution of a campaign is complete. For example, since campaigns are tracked, the computer may automatically process the characteristics of the customers along with information as to the success of the campaign per record (i.e., who bought and who didn't buy in that campaign). The computer can determine that men between the ages of 20 and 25 bought or that the product was much more successful selling in Europe to couples with children, etc. In other words segments and profiles of customer segments can be detected, identified, and/or augmented in a post-campaign manner. Once this intelligence is gathered, these models, segments, and/or information may be used to generate new list searches or new lists of customer records from the on-line system that are more targeted to a customers successful demographic.

As used herein, customer lists were intended to mean information pertaining to existing customers of a target entity and marketing lists were intended to mean prospective customers that are not yet current customers of the target entity. However, customer lists and marketing lists can mean any list of individuals, entities, corporations, or like that are used for any purpose and are sometimes used interchangeably herein. Also, as used herein, list owner may also mean their agents, service providers, or brokers and list end user may also mean their agents, service providers, and/or brokers. In addition, many different data structures and organizations as well as many different methods of forming, using, and maintaining those structures may be used to enable the teachings of FIGS. 8-13. It is to be understood, therefore, that the claims should not be limited to the particular forms and embodiments illustrated herein and that it is intended that the appended claims cover all modifications that do not depart from the spirit and scope of this invention.

What is claimed is:

1. A method comprising the steps of:
providing a construct in memory that associates direct marketing records within a plurality of segmented lists to ID tags whereby similar records in different lists are associated with the same ID tag;
receiving a direct marketing list from a list source;
scanning the direct marketing list to identify one or more new records in the direct marketing lists that are not represented in the construct;
creating one or more new entries in the construct to associate the one or more new records with new ID tags; and
using the ID tags to search the direct marketing records for use by an end user.

2. The method of claim 1 wherein the step of scanning comprises:
finding one or more records in the direct marketing list that are already represented within the construct whereby at least one existing ID tag data entry within the construct is updated to associate an existing ID tag with yet another record in the direct marketing list.

3. The method of claim 1 wherein each ID tag entry in the construct contains one or more pointers to one or more records within one or more direct marketing lists that contain related customer data.

4. The method of claim 1 wherein each ID tag entry in the construct contains an ID tag field, a name field, an address field, and at least one other field of information.

5. The method of claim 1 wherein the construct is scanned against a database in order to update information in the construct over time.

6. The method of claim 5 wherein the database is the national change of address database.

7. The method of claim 1 wherein the database is the national change of address database.

8. The method of claim 1 wherein the construct is structured in an alphabetic order to enable alphabetic based searching or locating of records within the construct during the step of scanning.

9. The method of claim 1 wherein the direct marketing lists is processed so that it may be accessed in an alphabetic order during the step of scanning where the processing to make the direct marketing list alphabetic does not alter the direct marketing list itself.

10. The method of claim 1 wherein the ID tag includes a household tag that identifies various direct marketing records associated with the same household.

11. The method of claim 1 wherein the ID tag includes a business tag that identifies various direct marketing records that are associated with the same business.

12. The method of claim 1 wherein the ID tag includes a characteristic tag that associates various direct marketing records which each other when all those direct marketing lists have that same characteristic.

13. A method comprising the steps of:
providing a list database containing a plurality of direct marketing records having different data field names and different data values;
receiving a direct marketing list having data records, each data record having data fields associated with data field names and data values;
scanning at least a portion of the direct marketing list to determine the data field names and the data values in the direct marketing list;
creating or updating information in one or more data conversion constructs in response to the determination of the data field names and the data values in the direct marketing lists to obtain an enhanced construct; and
using the enhanced construct and user input to search the lists for selected direct marketing records.

14. The method of claim 13 wherein the step of scanning determines that one data field name and the data values associated with that one data field name already recorded within the one or more data conversion constructs are sufficient to enable accurate searching of this data field name in the direct marketing list.

15. The method of claim 13 wherein the step of scanning determines that one data field name and the data values associated with that one data field name are not specifically represented within the one or more data conversion constructs but may be mapped to an existing data field name entry in the one or more data conversion constructs without the need for placing new data values in the one or more data conversion constructs.

16. The method of claim 13 wherein the step of scanning determines that one data field name and the data values associated with that one data field name are not exactly recorded within the one or more data conversion constructs but may be mapped to an existing data field name entry in the one or more data conversion constructs whereby one or more new data values are also created for that existing data field name entry in the one or more data conversion constructs.

17. The method of claim 13 wherein the step of scanning determines that one data field name and the data values associated with that one data field name cannot be correlated with any entries the one or more data conversion constructs where new entries are created in the one or more data conversion constructs containing the one new data field name and all the data values associated with that one data field name.

17. The method of claim 13 wherein the step of scanning determines that a data type of one of the data values is not compatible with existing data within the one or more data conversion constructs wherein data type conversion information is created within the one or more data conversion constructs to conform the data type to a standard data type.

18. The method of claim 13 wherein the step of scanning determines that a data format of one of the data values is not compatible with existing data within the one or more data conversion constructs wherein data format conversion information is created within the one or more data conversion constructs to conform the data format to a standard data format.

19. A method comprising the steps of:
providing a first construct in memory that associates direct marketing records within a plurality of segmented lists to ID tags whereby similar records in different lists are associated with the same ID tag;
providing a second construct in memory that allows for conversion of different data field tags and different data values in each of the plurality of segmented lists to a common search protocol;
receiving a new direct marketing list from a list source;
scanning the direct marketing list to update the first construct and the second construct to enable the new direct marketing lists to be searched with other of the plurality of segmented lists using the common search protocol; and
performing searches on the plurality of segmented lists, including the new direct marketing list, using the common search protocol.

20. A method comprising the steps of:
providing a first construct in memory that associates direct marketing records within a plurality of segmented lists to one or more ID tags whereby similar records in different lists are associated with the same ID tag;
providing a second construct in memory that allows for conversion of different data field tags and different data values in each of the plurality of segmented lists to a common search protocol;
receiving a new direct marketing list from a list source;
scanning the direct marketing list to:
(1) assign each record in the direct marketing list to either existing ID tags or one or more new ID tags that are placed within the first construct; and
(2) determine the data field names and an complete list of possible data values within the data fields for the direct marketing list; and
(3) using the data field names and the complete list of possible data values to update the second construct so that the data field names are correlated to standard field names and the data values are recognized by the second construct; and
performing searches on the plurality of segmented lists, including the new direct marketing list, using a common search protocol that uses the standard field names.

21. A data structure comprising:
a first construct that contains a plurality of entries, each entry containing a standard search data field name and at least one link field derived from a plurality of direct marketing lists; and
a second construct coupled to the first construct through one of the link fields within the at least one link field, the second construct mapping the different data field names in the plurality of direct marketing lists that are related to similar information to the same standard search data field name.

22. The data structure of claim 21 wherein the second construct contains entries wherein each entry comprises a list ID field for identifying a list associated with the entry, a different data field name, the standard search data field name, a unique code value, and a value field.

23. The data structure of claim 21 further comprising an additional construct coupled to the first construct through one of the link field within the at least one link field, the additional construct recording the values that are possible for each data field name in the first construct.

24. The data structure of claim 21 further comprising an additional construct coupled to the first construct through one of the link field within the at least one link field, the additional construct recording a hierarchical arrangement of various data field names in the first construct.

25. The data structure of claim 21 further comprising an additional construct coupled to the first construct through one of the link field within the at least one link field, the additional construct recording a data type for various data field names in the first construct.

26. The data structure of claim 21 further comprising an additional construct coupled to the first construct through one of the link field within the at least one link field, the additional construct recording one or more search operations that are possible for various data field names in the first construct.

27. The data structure of claim 21 further comprising an additional construct coupled to the first construct through one of the link field within the at least one link field, the additional construct recording function operators that may be used when searching one or more of various data field names in the first construct.
